(19) United States
(12) Patent Application Publication
(10) Pub. No.: US 2020/0193264 A1
(43) Pub. Date: Jun. 18, 2020

(54) SYNCHRONIZING VIRTUAL AGENT BEHAVIOR BIAS TO USER CONTEXT AND PERSONALITY ATTRIBUTES

(71) Applicant: AT&T INTELLECTUAL PROPERTY I, L.P., Atlanta, GA (US)

(72) Inventors: Eric Zavesky, Austin, TX (US); Nigel Bradley, McDonough, GA (US); Timothy Innes, Atlanta, GA (US); James Pratt, Round Rock, TX (US); Nikhil Marathe, Palatine, IL (US)

(21) Appl. No.: 16/221,418

(22) Filed: Dec. 14, 2018

(51) Int. Cl. G06N 3/00; G10L 25/63; G10L 15/22; G06K 9/00

(52) U.S. Cl. CPC G06N 3/006; G10L 25/63; G06K 9/00302; G06K 9/00664; G10L 2015/225; G10L 15/22

(57) ABSTRACT

Virtual agents (VAs) can be managed in interactions with communication devices (and associated users) or other VAs. A VA management component (VAMC) can track, and analyze information relating to, interactions between a VA and one or more users. During a current interaction of the VA with a user, VAMC can determine a current context of the user, environment associated with the user, and personality attributes of the user from the current and previous interactions. During the interaction, VAMC can manage the VA to modulate the behavior of the VA, responses of the VA, and personality attributes of the VA based on the current user context, environment, and personality attributes of the user. The VAMC also can manage the VA and adapt the personality attributes, behavior, and responses of the VA to the device that is implementing the VA and device capabilities of the device.

### TECHNICAL FIELD

This disclosure relates generally to electronic communications, e.g., to synchronizing virtual agent behavior bias to user context and personality attributes.

### BACKGROUND

Communication devices (e.g., landline phones, mobile phones, electronic pads or tablets, computers, . . . ) can be utilized to engage in electronic communications (e.g., voice and/or data traffic) between entities associated with the communication devices. Various services can be provided to and utilized by entities using communication devices in a communication network.

The above-described description is merely intended to provide a contextual overview regarding electronic communications, and is not intended to be exhaustive.

### BRIEF DESCRIPTION OF THE DRAWINGS

FIG. 1 illustrates a block diagram of an example system that can manage a virtual agent(s) (VA(s)) in interactions with users, in accordance with various aspects and embodiments of the disclosed subject matter.

FIG. 2 depicts a diagram of an example system that can overlay VA personality attributes of a VA onto an interaction between the VA and a user to facilitate managing the VA during the interaction, in accordance with various aspects and embodiments of the disclosed subject matter.

FIG. 3 presents a diagram of an example overlay of VA personality attributes onto an interaction and associated process with regard to an interaction between a VA and a user to facilitate managing the VA during the interaction, in accordance with various aspects and embodiments of the disclosed subject matter.

FIG. 4 depicts a block diagram of an example VA, in accordance with various aspects and embodiments of the disclosed subject matter.

FIG. 5 illustrates a block diagram of an example VA management component, in accordance with various aspects and embodiments of the disclosed subject matter.

FIG. 6 depicts a block diagram of example user equipment, in accordance with various aspects and embodiments of the disclosed subject matter.

FIG. 7 illustrates a flow chart of an example method that can manage a VA in interactions with a user, in accordance with various aspects and embodiments of the disclosed subject matter.

FIG. 8 presents a flow chart of another example method that can manage a VA in interactions with a user, in accordance with various aspects and embodiments of the disclosed subject matter.

FIG. 9 is a schematic block diagram illustrating a suitable operating environment.

FIG. 10 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Communication devices (e.g., landline phones, mobile phones, electronic pads or tablets, computers, devices in or integrated with vehicles, . . . ), can operate and communicate via wireline or wireless communication connections (e.g., communication links or channels) in a communication network to perform desired transfers of data (e.g., voice and/or data communications), utilize services, engage in transactions or other interactions, and/or perform other operations. For example, communication devices can be utilized to engage in online-related commerce and/or perform transactions between entities associated with the communication devices, wherein the entities can comprise human users or other users or entities, such as virtual agents (VAs) (also referred to as virtual assistants) and/or software entities or components. As another example, communication devices can be utilized to utilize or provide a service, wherein the communication session between the communication devices can involve one or more human users, one or more VAs, and/or one or more other entities (e.g., software entities or components).

As devices and VAs are increasingly anthropomorphized with stronger personalities and given additional responsibilities for personal interactions, the desire for strong alignment between a user context and device dialog state can grow. Rudimentary techniques may be employed to compute a user state (e.g., happy, sad, etc.) from a small collection of sensor modalities (e.g., voice, face, etc., of a user), but this often can be a shallow, instantaneous assessment of user sentiment. Further, the rules for long-term dialog states (or personality attributes) can be nascent in nature and typically not suitable to involve understanding when, for example, a joke or self-deprecating insult may be the appropriate tool to push a user experience forward. For instance, a challenging dialog with a user about paying bills may be able to be continued if, with regard to some users, the VA empathized with the user, and, with regard to other users, the VA joked with the user. Finally, while some VA systems may copy user preferences from device to device, they typically do not allow this personality migration to permute as it is given different responsibilities.

To that end, techniques for managing VAs in interactions with communication devices (and associated users) or other VAs are presented. A VA management component (VAMC) can track, and analyze information relating to, interactions between a VA and one or more users and/or one or more communication devices associated with the one or more users. During a current interaction of the VA with a user and/or associated communication device, the VAMC can determine a current context of the user, an environment associated with the user, and/or personality attributes of the user based at least in part on the results of analyzing information relating to the current and previous interactions. For instance, personality attributes determined by the VAMC (or another VAMC or other component) can be stored in a user profile associated with the user. When interacting with the user or associated communication device, the VAMC can access the user profile associated with the user and can access the personality attributes of the user from the user profile. During the interaction, based at least in part on the personality attributes of the user, and the current context and/or environment associated with the user, as determined by the VAMC, the VAMC can manage the VA to modulate, modify, or tailor the behavior of the VA, responses of the VA, and characteristics of the VA.

In some embodiments, the VAMC can manage the VA and adapt the characteristics, behavior, and responses of the VA to the device that is implementing or associated with the VA and device capabilities of the device. For example, the VA can be implemented using or associated with a first device that can comprise a first set of characteristics, functions, interfaces, etc., and/or can be associated with a first environmental setting. The VAMC can manage the VA, including the characteristics (e.g., VA attributes) of the VA, based at least in part on the first set of characteristics, functions, interfaces, etc., and/or the first environmental setting. In another instance, the VA can be implemented using or associated with a second device that can comprise a second set of characteristics, functions, interfaces, etc., and/or can be associated with a second environmental setting. The VAMC can manage the VA, including the characteristics of the VA, based at least in part on the second set of characteristics, functions, interfaces, etc., and/or the second environmental setting.

These and other aspects and embodiments of the disclosed subject matter will now be described with respect to the drawings.

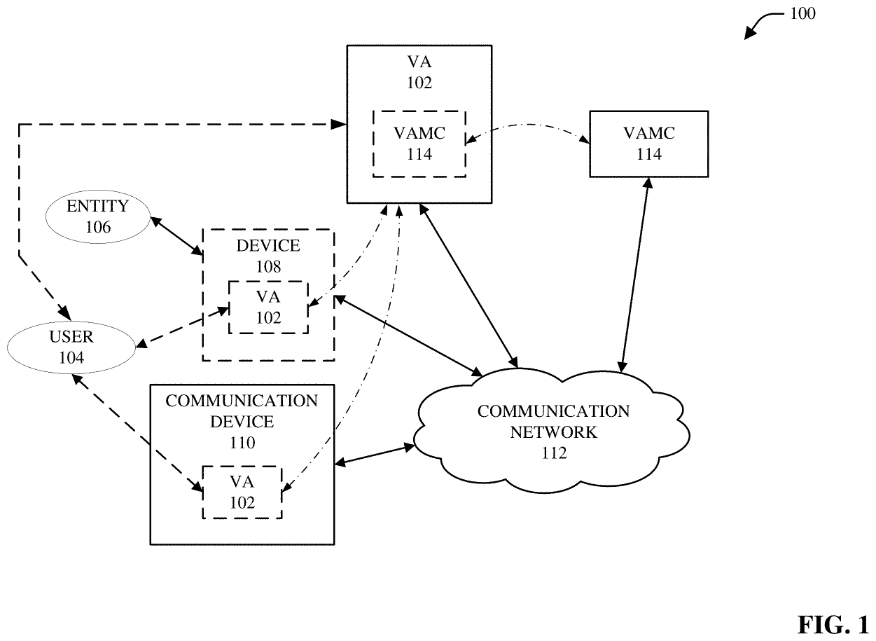

Referring now to the drawings, FIG. 1 illustrates a block diagram of an example system 100 that can manage a VA(s) in interactions with users (e.g., users and/or communication devices associated with users), in accordance with various aspects and embodiments of the disclosed subject matter. The system 100 can comprise a VA 102 that can interact with a user 104 and perform various tasks for or on behalf of the user 104 and/or an entity 106 that can be associated with the VA 102. The entity 106 (if any) can be a business entity (e.g., store, company, service provider, . . . ) that provides or sells products or services, or another type of entity (e.g., person, medical provider, or law enforcement, . . . ). In some embodiments, the VA 102 can be included in, integrated with, or implemented via a device 108, and the entity 106 can provide or sell the device 108 (e.g., to the user 104). In other embodiments, the VA 102 can be included in, integrated with, or implemented via a communication 110 associated with the user 104.

In accordance with various embodiments, the user 104 can interact directly with the VA 102 and/or device 108 associated therewith, and/or the user 104 can interact with the VA 102 via the communication device 110 associated with the user 104, wherein the VA 102 or device 108 associated therewith can communicate with the communication device 110 via a direct communication connection or via a communication network 112. A communication device (e.g., communication device 110, device 108, . . . ) can be, for example, a mobile and/or wireless communication device, such as a mobile phone, a landline or wireline phone, a device comprising a VA, an electronic notebook, an electronic pad or tablet, an electronic gaming device, a personal digital assistant (PDA), electronic bodywear (e.g., electronic or smart glasses, electronic or smart watch), a computer, a set-top box, or other type of communication device that can operate and communicate in a communication network environment (e.g., communication network 112).

The communication network 112 can comprise a radio access network (RAN) (not shown) that can comprise or be associated with a set of base stations (e.g., access points (APs)) (not shown) that can serve communication devices (e.g., communication device 110, device 108, . . . ) located in respective coverage areas served by respective base stations in the communication network 112. In some embodiments, the RAN can be a cloud-RAN (C-RAN) that can be located in or associated with a cloud computing environment, comprising various cloud network components of the communication network 112.

The respective base stations can be associated with one or more sectors (not shown), wherein respective sectors can comprise respective cells. The cells can have respective coverage areas that can form the coverage area covered by the one or more sectors. The respective communication devices (e.g., 108, 110, . . . ) can be communicatively connected to the communication network 112 via respective wireless or wireline communication connections with one or more of the respective cells.

The VA 102 (and/or associated device 108) can be associated with (e.g., communicatively connected to) the communication network 112. It is to be appreciated and understood that, while the disclosed subject matter is typically described with regard to VAs, another type of software-based entity can be employed to perform the functions of the VAs, as described herein. It is to be appreciated and understood that, while some aspects of the disclosed subject matter are described where the user 104 can use the communication device 110 for communication (e.g., transmission, reception) of information (e.g., interaction-related and/or event-related information) to or from another device (e.g., another communication device, a VA, . . . ), in certain aspects of the disclosed subject matter, the user 104 can communicate information using, and can receive information from, the VA 102 (or associated device 108) (e.g., by speaking into an interface of or associated with the VA 102 (or device 108), by receiving (e.g., hearing, viewing) information presented via an interface of or associated with the VA 102 (or device 108)). For example, a VA 102 can be associated with (e.g., integrated with, attached to) a vehicle of the user 104, wherein the user can use (e.g., communicate using) the VA 102 with regard to one or more services that can be provided using or facilitated by the VA 102.

A VA (e.g., 102) can be a domain-specific VA or can be a generalized (or at least more generalized) VA. For example, a domain-specific VA can be created and utilized to provide products or services for one or a relatively small subset of domains (e.g., a VA that provides or facilitates providing food-related products or services; a VA that provides or facilitates providing video and/or audio content-related products or services; a VA that provides or facilitates providing sports-related products or services; . . . ). As another example, a generalized (or more generalized) VA can be created and utilized to provide products or services for all domains or at least a relatively large subset of domains. The disclosed subject matter can enable the use of VAs to act as intermediaries and/or navigators for and on behalf of users and/or other entities, for example, with regard to interactions (e.g., transactions).

The system 100 can include a VA management component 114 (VAMC) that can manage (e.g., control) interactions and communications by the VA 102 with the user 104 and/or associated communication devices (e.g., communication device 110), and/or between the VA 102 and another VA (if any), etc., in accordance with defined VA management criteria. In some embodiments, the VAMC 114 can be included in, integrated with, implemented via, or otherwise associated with the VA 102. In other embodiments, the VAMC 114 can be a stand-alone unit, can be part of another device or component, or can be distributed among various devices and components, wherein the VAMC 114 can be associated with (e.g., connected to) the VA 102 to facilitate communicating with and managing the VA 102.

In certain embodiments, the VAMC 114 can determine a personality overlay, based at least in part on VA personality attributes determined for the VA 102, wherein the VA personality attributes can be determined based at least in part on personality attributes of the user 104, as more fully described herein. The VAMC 114 can manage the VA 102 to have the VA 102 (or another VA) implement the personality overlay during an interaction between the VA 102 (or other VA) and the user 104, as more fully described herein. The VAMC 114 can determine the personality overlay to be used by the VA 102 during an interaction with the user 104 based at least in part on (e.g., to consider or take into account) the contexts or sentiments of the user 104 during the interaction, personality attributes of the user 104, the environment associated with the user 104, the current experience or workflow associated with the user 104, and/or other factors. The VAMC 114 can determine respective personality overlays for respective users and respective associated factors (e.g., contexts, sentiments, user personality attributes, environment, . . . ). The personality overlays can allow variant and appropriate responses to be made by the VA 102 (or other VAs) to respective users, such as user 104. For example, the VAMC 114 can control the VA 102 to have the VA 102 behave and interact differently while reading text messages aloud to a user 104, if the user 104 was an active airplane pilot as compared to if the user 104 was a child playing chess. Further, the VAMC 114 can manage the VA 102 to have the VA 102 approximate a desirably number of human dialog states (e.g., mirroring or empathy, . . . ), wherein the VAMC 114 can manage the VA 102 to modulate the behavior and characteristics of the VA 102 according to the task at hand for the VA 102, such that the VA 102 asking the same user 104 for the same password in a single interaction session can range from the VA 102 being jovial to the VA 102 being serious.

As disclosed, the VAMC 114 can apply VA personality attributes, which can relate to personality attributes of the user 104, to the VA 102 to facilitate managing the behavior of the VA 102 during the interaction with the user 104. The VA personality attributes, which are more fully described herein, can range significantly beyond merely happy and sad, and the VA personality attributes can be multi-dimensional (e.g., multiple VA personality attributes can be exhibited at the same time and to respective degrees) and can influence or dictate the actions and responses of the VA 102 during the interaction with the user 104.

The VAMC 114 also can control the VA 102 to test or probe the user 104 during the interaction to discover the desired (e.g., optimal, suitable, acceptable, accurate, or sufficiently accurate) sentiment and dialog state to be used by the VA 102 during the interaction, or portion thereof, with the user 104. For instance, the VAMC 114 can control the VA 102 to test or probe the user 104, through various questions, responses, or actions of the VA 102 to or with respect to the user 104, to facilitate manipulation and discovery of the personality attributes of the user 104, wherein the attribute manipulations can grow from small to larger as the VAMC 114 learns or determines more about the sentiments, personality attributes, and/or contexts of the user 104. The VAMC 114 can learn when to apply (e.g., when to have the VA 102 apply) different dialog states and sentiment (e.g., sentiment of the VA 102 that can mimic the sentiment of the user 104, sentiment of the VA 102 that can complement the sentiment of the user 104, . . . ) for different user contexts of the user 104 during the interaction. In some embodiments, the VA 102 (e.g., as managed by the VAMC 114) can perform contextually appropriate testing or probing of the user 104 to obtain or collect (e.g., gather) further consumer interests of the user 104. For instance, if during an interaction between the VA 102 and user 104, the VA 102 hears a child in the background, the VA 102 can simulate or emulate human interaction with the user 104, for example, to ask the user 104 how old the child is (e.g., to determine potential consumer interests of the user 104 with respect to the child).

The VAMC 114 also can adapt the VA personality attributes of the VA 102 based at least in part on the device(s) (e.g., device 108, communication device 110, . . . ), and the respective (e.g., particular) capability of the device(s), through which the VA 102 is interacting with the user 104. The VAMC 114 can provide and implement a set of rules for adaptation of VA personality attributes by (e.g., based at least in part on, or in accordance with) device(s) and respective capabilities of devices, and can understand how to desirably use (e.g., how to best or optimally use) one or more of various (e.g., multiple) outputs (e.g., output interfaces, such as a display screen, audio speakers, . . . ) of one or more devices (e.g., 108, 110, . . . ) that can be associated with the VA 102 (e.g., one or more devices through which the VA 102 can interact with the user 104). For instance, based at least in part on the device and capability, the VAMC 114 can manage the VA 102 by weighting respective VA personality attributes and/or weighting various types of actions and responses that the VA 102 can execute or perform during the interaction, based at least in part on the various outputs available as well as the context, sentiment, and personality attributes of the user 104 and environmental conditions of the environment associated with the user 104, to determine which output(s) to use to communicate or converse with the user 104 and/or the type of response or action to execute during the interaction. For example, the VAMC 114 can apply desired weights to various outputs and/or weights to various types of actions and responses that the VA 102 can execute or perform to downplay having the VA 102 be talkative and/or empathetic to the user 104 (e.g., downplay the VA personality attributes of talkative and/or empathy), if the VA 102 is communicating with the user 104 via a loudspeaker where other people also may be able to hear what the VA 102 is presenting (e.g., saying) to the user 104, and instead the VA 102 can communicate information to the user 104 using more generic, non-intrusive or less intrusive imagery that can be displayed on a display screen of a device. When the user 104 is communicating with the VA 102 through a personal mobile device, such as communication device 110 (e.g., smart phone, electronic table, or laptop computer), the VAMC 114 can apply different weights to the various outputs and/or to the various types of actions and responses, based at least in part on the outputs available through the personal mobile device (e.g., the VAMC 114 can weight the talkative and/or empathy VA personality attributes to place more emphasis on such VA personality attributes to have the VA 102 present a more talkative and/or empathetic response (e.g., vocal response) to the user 104 via a speaker(s) or earbuds of or associated with the personal mobile device.

In some embodiments, the VAMC 114 can monitor and track interactions between the user 104 (and/or associated communication device 110) and the VA 102 (or another VA(s)) to determine respective contexts of the respective interactions, including respective contexts of the user 104, personality attributes or sentiments of the user 104, and/or respective environmental conditions of an environment associated with the user 104 during the respective interactions. From the monitoring and tracking of the interactions, based at least in part on the results of analyzing information relating to the interactions between the user 104 (and/or associated communication device 110) and the VA 102 (or another VA(s)), the VAMC 114 can determine the respective contexts of the respective interactions, including the respective contexts of the user 104, the personality attributes or sentiments of the user 104, and/or the respective environmental conditions during the respective interactions. In determining (e.g., determining or inferring) the personality attributes of the user 104 during one or more interactions, the VAMC 114 can determine, learn, and/or refine (e.g., refine the determination of) the personality attributes of the user 104 over time. The VAMC 114 can store (e.g., in a data store) information relating to the personality attributes and sentiments of the user 104 and/or other information (e.g., context information, environmental conditions information) relating to the interactions of the VA 102 with the user 104 in a user profile for the user 104.

The personality attributes of users (e.g., user 104), which can be learned or determined by the VAMC 114, can comprise (and can range from) more general personality attributes and/or more specific personality attributes of users. For instance, the personality attributes of users can be more general in that a user often or typically can exhibit a particular personality attribute(s) under a variety of contexts or conditions (e.g., the VAMC 114 learns or determines that a particular user is often or typically happy, nice, funny, extroverted, and/or talkative; or the VAMC 114 learns or determines that another user is often or typically sarcastic, extroverted, talkative, and/or aggressive; or the VAMC 114 learns or determines that still another user is often or typically nice, introverted, and/or not very talkative; . . . ). The personality attributes of users can be more specific in that a user can exhibit a particular personality attribute(s) or sentiment(s) under a particular context(s) or condition(s) (e.g., the VAMC 114 learns or determines that a particular user is irritated, angry, and/or unhappy under certain conditions or contexts, even if the particular user is determined to generally or typically be more happy, nice, or funny under a variety of other conditions or contexts; or the VAMC 114 learns or determines that another user can be sarcastic, talkative, and/or aggressive under particular conditions or contexts, even if such other user is determined to generally or typically be more jovial and nice under a variety of other conditions or contexts; . . . ).

When the VA 102 begins an interaction (e.g., current or new interaction) with the user 104, the VAMC 114 can retrieve the user profile of the user 104 from the data store and can utilize the information relating to the personality attributes of the user 104 and/or the other information of the user profile to manage the VA 102 during the interaction with the user 104, including managing the VA personality attributes of the VA 102, the characteristics of the VA 102 and/or the responses or other interactions of the VA 102, during the interaction, based at least in part on a current context of the interaction and/or user 104, the personality attributes or sentiment(s) (e.g., current sentiment) of the user 104, and/or current environmental conditions of the environment associated with the user 104, in accordance with the defined VA management criteria.

Initially, the VAMC 114 can manage the operation of the VA 102 during the interaction based at least in part on the personality attributes of the user 104, VA attributes of the VA 102, and/or other information obtained from the user profile. As the interaction progresses, the VAMC 114 can manage the operation of the VA 102 during the interaction to take into account the context of the user 104 or interaction overall, the sentiment of the user 104 during the interaction, learned or determined personality attributes of the user, or refinements or modifications thereto, adjustments to VA personality attributes, and/or environmental conditions of the environment associated with the user 104.

For instance, during the interaction, the VAMC 114 can monitor and track the interaction between the VA 102 and the user 104 with regard to an event. The event can be or relate to, for example, a vehicle accident (e.g., vehicle accident involving the user 104), a potential purchase of a product or service, another type of transaction, a medical situation or emergency (e.g., injury or medical condition or emergency involving the user 104 or another person), a legal or criminal situation (e.g., theft, robbery, assault, or homicide), or another type of event. The VAMC 114 can receive, obtain, or generate information relating to the interaction. For instance, the VAMC 114 can receive or obtain information relating to the interaction from the VA 102, communication device 110, and/or another source(s) (e.g., sensors and/or another device(s), such as an Internet of Things (IoT) device(s)), based at least in part on the tracking of the interaction. The VAMC 114 also can generate interaction-related information based at least in part on the tracking of the interaction and/or the received or obtained interaction-related information. The interaction-related information can comprise event information relating to the event, information (e.g., event or other information) exchanged between the VA 102 and user 104, and/or another participant(s) of the interaction, characteristics of the VA 102 during the interaction, historical information regarding the VA 102 and/or user 104, and/or other desired information relating to the interaction.

During the interaction, the VAMC 114 can analyze the information relating to the interaction to determine a context of the user 104 or interaction overall, the sentiment of the user 104 during the interaction, personality attributes of the user 104 (e.g., personality attributes being exhibited by the user 104 during the interaction), and/or the environmental conditions of the environment.

For instance, as part of determining the context of the interaction, the VAMC 114 can analyze the interaction-related information to determine whether the exchange of information (e.g., event information) between the VA 102 and the user 104 is proceeding at a desirable (e.g., acceptable, suitable, optimal, or sufficiently fast) pace or is proceeding at an undesirable (e.g., unacceptable or unduly slow) pace, whether or not the user 104 appears to be having difficulty in understanding the verbal words (e.g., audible words) presented by the VA 102 to the user 104, and/or whether or not the VA 102 appears to be having difficulty in understanding the verbal words communicated by the user 104 to the VA 102. The VAMC 114 also can analyze the interaction-related information, as part of determining the context of the interaction, to determine the status or progress of the interaction, what event information has been exchanged or collected, what event information is still desired (e.g., to otherwise complete the tasks associated with the interaction, to complete an insurance claim, or to complete a transaction), what type of information (e.g., event information, consent from the user 104, . . . ) is desired to be obtained next or within a defined amount of time (e.g., in the near future) in the interaction, characteristics of the VA 102 during the interaction, and/or relevant historical data or characteristics regarding the VA 102.

Further, as part of determining the context of the interaction, the VAMC 114 can analyze the interaction-related information with regard to characteristics of the user 104. For example, based at least in part on the results of analyzing interaction-related information relating to characteristics of the user 104, the VAMC 114 can determine characteristics of the user 104, such as a focus of attention of the user 104 (e.g., whether the user 104 is focused on the interaction or is focused, or partially focused, on something else), status, including health status, of the user 104 (e.g., healthy, injured, conscious, unconscious, responsive, non-responsive, heart rate, blood pressure, and/or other health or biometric status information), biometric or physical information of the user 104 (e.g., facial expression, eye focus or movement, movement or location of hands or legs, . . . , of the user 104), location of the user 104 relative to the location of an event, gender of the user 104, age of the user 104, demographic information associated with the user 104, and/or other characteristics of or associated with the user 104. The VA 102 and/or VAMC 114 can receive information (e.g., sensor data) relating to such characteristics of the user 104 from one or more sensors of or associated with the VA 102 or VAMC 114, other devices (e.g., computer, mobile phone, or electronic bodywear, . . . ) associated with the VA 102 or VAMC 114, and/or a service (e.g., a central service that collects such information from sensors), for example. The one or more sensors can comprise health-related sensors (e.g., sensor to measure body temperature, sensor to measure blood pressure, sensor to measure heart rate, and/or other health-related sensors), biometric sensors (e.g., eye, iris, facial, voice, fingerprint, and/or other biometric sensors) environment-related sensors (e.g., air temperature sensor, humidity sensor, smoke sensor, allergen sensor, pollution sensor, or other environment-related sensors), audio sensors (e.g., microphone(s)), visual sensors (e.g., camera(s)), and/or other desired types of sensors.

Also, as part of determining the sentiment of the user 104 during the interaction, the VAMC 114 can analyze the interaction-related information, and in particular, information relating to the responses or actions of the user 104, to determine the sentiment of the user 104 during the interaction (or at a particular point in the interaction). For instance, the VAMC 114 can analyze the words, voice characteristics, facial expressions, hand or body gestures, other responses or actions of the user 104, and/or other interaction-related information to determine the sentiment of the user 104. The VAMC 114 can employ visual analysis and recognition techniques, audio or voice analysis and recognition techniques, and/or other techniques to analyze such interaction-related information associated with the user 104 to facilitate determining the sentiment of the user 104.

Based at least in part on the results of analyzing the interaction-related information, during the interaction, the VAMC 114 can determine the sentiment of the user 104 across a wide range of sentiments that a user 104 potentially can experience. The range of sentiments of the user 104 can comprise, for example, happy, sad, ambivalent, joyful, gleeful, melancholy, upset, irritated, hopeful, defensive, offensive, afraid, nervous, cautious, angry, hurt, disgusted, surprised, and virtually any other sentiment that a person can experience.

Further, as part of determining, learning, or refining (e.g., refining the determination of) the personality attributes of the user 104 during the interaction, the VAMC 114 can analyze the interaction-related information, and in particular, information relating to the responses or actions of the user 104, to determine one or more personality attributes that the user 104 is exhibiting during the interaction (or at a particular point in the interaction). For instance, the VAMC 114 can analyze the words, voice characteristics, facial expressions, hand or body gestures, other responses or actions of the user 104, and/or other interaction-related information to determine one or more personality attributes that the user 104 is exhibiting during the interaction (or at a particular point in the interaction). The VAMC 114 can employ visual analysis and recognition techniques, audio or voice analysis and recognition techniques, and/or other techniques to analyze such interaction-related information associated with the user 104 to facilitate determining such personality attributes of the user 104.

Based at least in part on the results of analyzing the interaction-related information, during the interaction, the VAMC 114 can determine, learn, or refine the personality attributes of the user 104, wherein the personality attributes of the user 104 can be from across a wide range of personality attributes that a user 104 potentially can have. The range of personality attributes of the user 104 can comprise, for example, extroverted, gregarious, introverted, withdrawn, sociable, friendly, kind, humble, funny, witty, humorous, jovial, charming, adventuresome, optimistic, precise, reliable, meticulous, carefree, impulsive, sarcastic, arrogant, self-centered, unreliable, unfriendly, unkind, rude, cruel, and virtually any other personality attribute that a person can have.

In some embodiments, based at least in part on the results of analyzing the interaction-related information, the VAMC 114 can contextually adapt the personality attributes of the user 104, as learned or determined by the VAMC 114, across different devices (e.g., device 108, communication device 110, and/or another type of device(s)). For example, the VAMC 114 can determine and implement (via the VA 102) a first adaptation of the personality attributes of the user 104 when communicating with the user via a first device (e.g., device 108), and can determine and implement (via the VA 102) a second adaptation of the personality attributes of the user 104 when communicating with the user via a second device (e.g., communication device 110). The VAMC 114 can understand, for example, when the VA 102 is to engage more directly or to regard multi-person interactions (e.g., involving the user 104 and another person(s)) even with a stronger underlying personality. The VAMC 114 also can learn more long-term personality attributes of the user 104 and/or which personality attributes of the user 104 are more long term (e.g., enduring) as opposed to other personality attributes of the user 104, wherein the user 104 may have personality attributes that can indicate, for example, a preference for comedy, a preference for facts (e.g., more factual information, as opposed to opinion or gossip), and/or a preference that can indicate when the VA 102 is to be more passive in a conversation with the VA 102.

Furthermore, during the interaction, the VAMC 114 can analyze the interaction-related information, which can comprise environment-related information, to determine environmental conditions of the environment (e.g., house, room, building, vehicle, indoor, or outdoor, . . . ) associated with the user 104. For example, based at least in part on the results of analyzing the environment-related information, the VAMC 114 can determine a temperature level or weather conditions of the environment (e.g., sunny, cloudy, rain, snow, windy, . . . ), noises (e.g., baby crying, television or audio system presenting content, washing machine operating, vacuum cleaner operating, . . . ) in the environment, noise levels (e.g., background noise levels) of the environment, an environment location (e.g., inside a home, building, a particular room, . . . ; outside on a street, in a rural area, in a park, on a farm, . . . ; at a venue, such as a ballpark, a stadium, a concert venue, . . . ; at a restaurant, a bar, a casino, . . . ; etc.), and/or other environmental conditions of the environment.

Based at least in part on, and in response to, personality attributes or sentiment(s) of the user 104, the context of the interaction or user 104, and/or environmental conditions associated with the user 104, the VAMC 114 can manage, modify, or modulate the characteristics of the VA 102 to manage, modify, or modulate VA personality attributes of the VA 102 being exhibited by the VA 102 to the user 104, the presentation of verbal words by the VA 102 to the user 104, and/or other interaction of the VA 102 with the user 104 (e.g., display of visual images on a display screen for viewing by the user 104; presentation of audio content, such as songs, jokes, etc., to the user 104; . . . ), in accordance with the defined VA management criteria.

In some embodiments, the VAMC 114 can determine VA personality attributes of the VA 102 that can be exhibited by the VA 102 to the user 104 during the interaction to facilitate enhancing the experience of the user 104 during the interaction and/or achieving a desirable (e.g., optimal, improved, or acceptable) outcome of the interaction between the VA 102 and the user 104. For instance, the VA personality attributes of the VA 102 can correspond to, mimic, simulate, emulate, complement, or supplement the personality attributes of the user 104 (e.g., as determined or learned by the VAMC 114). For example, if the VAMC 114 determines that the user 104 has personality attributes that include funny and extroverted, the VAMC 114 can determine VA personality attributes (e.g., of the VA 102 or another VA) that can include funny and extroverted, and/or other VA personality attributes that can complement, supplement, or otherwise be compatible with the funny and extroverted personality attributes of the user 104. When the VA 102 or another VA is interacting with the user 104, the VAMC 114 can retrieve the VA personality attributes from the user profile of the user 104, and can overlay the VA personality attributes onto the interaction by loading the VA personality attributes into the VA 102 or other VA that is interacting with the user 104.

The VAMC 114 also can determine respective characteristics and respective parameters (e.g., parameter values) of characteristics that can produce (e.g., generate) the respective VA personality attributes of the VA 102. For example, the VAMC 114 can determine that a first set of characteristics and a first set of parameters of the first set of characteristics can produce a first VA personality attribute of the VA 102, and a second set of characteristics and a second set of parameters of the second set of characteristics can produce a second VA personality attribute of the VA 102. The VAMC 114 can map the respective VA personality attributes of the VA 102 to the respective characteristics and the respective parameters of the respective characteristics to facilitate controlling the VA personality attributes based at least in part on the respective characteristics and the respective parameters of the respective characteristics associated with the VA 102.

The VAMC 114 can control the characteristics, and parameters of the characteristics, of the VA 102 to enable the VA 102 to have or model the VA personality attributes of the VA 102 during the interaction. The VA personality attributes can correspond to, mimic, simulate, emulate, complement, or supplement personality attributes of human users, and, in particular, the user 104, so that the interaction between the VA 102 and the user 104 can closely correspond to how an interaction between a human user (instead of the VA 102) and the user 104 would be, can enhance the user experience of the user 104, and/or can improve the likelihood that desirable (e.g., positive, optimal, satisfactory, or acceptable) results for the user 104 can be achieved during the interaction with the VA 102.

The characteristics of the VA 102 can comprise, for example, a speed (e.g., rate) or cadence of verbal words being presented by the VA 102 to the user 104 or associated communication device 110, a tone or inflection of a virtual or emulated voice being presented by the VA 102, a volume of the virtual or emulated voice being presented by the VA 102, a language or dialect of the virtual or emulated voice being presented by the VA 102, and/or a vocabulary level of the virtual or emulated voice being presented by the VA 102. The characteristics of the VA 102 also can comprise or relate to the types of visual images, video content, audio content, or other content the VA 102 presents to the user 104.

As the interaction continues, if the VAMC 114 determines that the context has changed (e.g., at a subsequent time), the sentiment of the user 104 has changed, there is a newly learned or refined personality attribute(s) of the user 104, and/or the environmental conditions have changed, the VAMC 114 can determine whether there is to be a change in the operation of the VA 102 at that point in the interaction. For instance, the VAMC 114 can determine whether one or more characteristics of the VA 102, one or more VA personality attributes of the VA 102, one or more interfaces (of the VA 102 or other device(s) associated therewith) used by the VA 102, and/or one or more types of information presented to the user 104, etc., are to be modified, based at least in part on determining that there has been a change in the context, user sentiment, personality attributes of the user 104, and/or environmental conditions, in accordance with the defined VA management criteria. In response to determining that there has been a change in the context, user sentiment, personality attributes of the user 104, and/or environmental conditions, the VAMC 114 can control the operation, including the characteristics, of the VA 102, to modify the operation, including modifying the characteristics (e.g., modifying the speed or cadence of verbal words being presented by the VA 102 to the user 104, modifying a tone or inflection of a virtual or emulated voice of the VA 102 being presented to the user 104, . . . ), of the VA 102 to account for such determined change(s) to enhance the interaction between the VA 102 and the user 104 (or communication device 110 associated with the user 104).

For example, if, in determining (e.g., determining a change of) the context, sentiment of the user 104, or personality attributes of the user 104, the VAMC 114 determines that the user 104 is having becoming irritated by the statements or questions presented by the VA 102, and such irritation is determined to be due in part to the speed or cadence of the verbal words being presented by the VA 102 to the user 104, and/or the tone or inflection of a virtual or emulated voice of the VA 102 being presented to the user 104, the VAMC 114 can determine that the speed or cadence is to be modified (e.g., to decrease the speed of presentation of verbal words and/or to adjust the cadence), and/or the tone or inflection of the virtual or emulated voice of the VA 102 is to be modified, to facilitate having the VA 102 present the verbal words to the communication device 110 of the user 104 at a speed, using a cadence, using a tone, and/or using a voice inflection, that can enhance (e.g., improve) the interaction with the user 104, including reducing the irritability of the user 104 with regard to the interaction with the VA 102. Additionally, or alternatively, based at least in part on the current context or sentiment of the user 104, and/or personality attributes of the user 104, the VAMC 114 can determine that, due to certain personality attributes (e.g., comedic, funny, humorous, . . . ) of the user 104, there is a likelihood (e.g., a defined threshold of likelihood) that the user 104 will respond positively to humorous interaction with the VA 102 while responding to the questions or statements of the VA 102, the VAMC 114 can determine some humorous content (e.g., joke, funny story, . . . ), which can (but does not have to) include contextually relevant humorous content, that the VA 102 can present to the user 104 while the VA presents further statements or questions to reduce the level of irritability of the user 104 during the interaction. The VA 102 (e.g., as managed by the VAMC 114) can present such further statements or questions based at least in part on the modified characteristics and/or to include the humorous interaction with the user 104. In some embodiments, the humorous interaction can relate to particular humor or comedic interests (e.g., sub- or micro-genres of humor or comedic interests) of the user 104, such as a favorite comedian, favorite comedy movie, or favorite comedy television show of the user 104, as has been learned or determined by the VAMC 114 during the interaction or previous interactions with the user 104.

As another example, if, in determining the context of the user 104, sentiment of the user 104, and/or personality attributes of the user 104, the VAMC 114 determines that the user 104 is readily (e.g., quickly) understanding and responding to questions (e.g., event-related questions) presented by the VA 102, and the user 104 is determined to be in an amenable and focused mood, the VAMC 114 can determine that the speed of the presentation of verbal words of the VA 102 to the user 104 can be modified to increase the speed of presentation of verbal words to the user 104 to facilitate having the VA 102 present the verbal words to the user 104 (and/or communication device 110 of the user 104) at a speed that can enhance (e.g., improve) the interaction (e.g., by enabling the conversation between the user 104 and the VA 102 to proceed at a faster pace) while still enabling the user 104 to understand the verbal words (e.g., statements or questions) being presented by the VA 102 and respond to the statements or questions presented by the VA 102.

In some embodiments, the VAMC 114 can employ techniques or methods that can modify or recommend (e.g., suggest) different semantic, visual, and/or timing interactions that can be customized by a dialog state of the dialog between the VA 102 and the user 104. This can, for example, enable the VA 102 to immediately synchronize or synchronize substantially immediately with the context of the user 104 (e.g., the VA 102 can immediately or substantially immediately synchronize its contextually determined responses or actions with the context of the user 104).

During the interaction or subsequent to the completion of the interaction between the VA 102 and the user 104, as desired, the VAMC 114 can update the user profile of the user 104 to include desired information relating to the interaction to facilitate improving the current or future interactions between a VA (e.g., VA 102) and the user 104, in accordance with the VA management criteria. For instance, the VAMC 114 can update the user profile of the user 104 to include information comprising or relating to the dialog or other interaction (e.g., media presentation, online information presentation, . . . ) between the VA 102 and user 104 during the interaction, any new, learned, updated, or refined personality attributes of the user 104, any new, updated, or refined VA personality attributes, the sentiment(s) and user context(s) of the user 104 during the interaction, the modulations or modification of characteristics of the VA 102 performed during the interaction (e.g., in relation or in response to the sentiment(s), user context(s), and/or personality attributes of the user 104, and/or environmental conditions of the environment), engagement attribute preferences regarding the user 104 that were learned or determined during the interaction, the results of any probing or learning with respect to the user 104 that was performed by the VA 102 during the interaction to learn more about the user 104 (e.g., learn more about the personality of the user), the actions taken by the VA 102 (e.g., in relation to the sentiment(s) or context(s) of the user 104, and/or the environmental conditions of the environment) during the interaction, the device(s) and/or output mechanism(s), output interface(s), or other device resource(s) utilized by the VA 102 during the interaction, and/or the results of the interaction (e.g., the level of success of the interaction, whether the desired goal of the interaction was achieved, . . . ).

The VAMC 114 can store the user profile, as updated, of the user 104 in a data store of or associated with the VAMC 114, wherein the user profile of the user 104 can be used during a future interaction between the user 104 and a VA (e.g., VA 102 or another VA). For instance, in a subsequent interaction between a VA (e.g., VA 102 or another VA) and the user 104, the VAMC 114 can retrieve the user profile of the user 104 from the data store, and can load the user profile (e.g., relevant profile information from the user profile) into the VA (e.g., VA 102 or other VA that is to interact with the user 104). The VA (e.g., VA 102 or other VA) can interact with the user 104, based at least in part on the profile information loaded from the user profile of the user 104, and/or based at least in part on the management of the VA by the VAMC 114, such as more fully described herein.

In certain embodiments, if the VA 102 (e.g., a personal VA of the user 104) is engaged with another VA (e.g., digitally using non-verbal VA-to-VA communication, or over a phone conversation, . . . ), the VAMC 114 or VA 102 (e.g., as managed by the VAMC 114) can convey attributes (e.g., personality attributes of the user 104 and/or VA personality attributes) and/or other desired information (e.g., sentiment and/or context) relating to the user 104 or interaction to a remote party or device, and can thereby allow remote customization of the content or environment presented or conveyed to the user 104 (e.g., by the remote party or device) based at least in part on the preferences of the user 104, sentiment of the user, and/or context of the user, etc. (e.g., as stored in the user profile of the user 104).

In some embodiments, the VAMC 114 and one or more VAs (e.g., VA 102 and/or another VA) can perform various tasks simultaneously, substantially simultaneously, or in parallel. For example, when a vehicle accident has occurred and the user 104 has been injured, the VAMC 114 can manage one or more VAs to have one VA (e.g., VA 102) contact and interact with emergency medical services (EMS) or other medical personnel (e.g., a VA or communication device of EMS or other medical personnel), another VA contact and interact with the insurance company of the user 104 (e.g., a VA or communication device of the insurance company) to notify the insurance company regarding the accident and initiate an insurance claim, still another VA contact and interact with law enforcement (e.g., a VA or communication device of law enforcement) to notify law enforcement regarding the accident (e.g., location and details of the accident), and/or yet another VA contact and interact with a towing company (e.g., a VA or communication device of the towing company) to request that the towing company come to the scene of the accident and tow the vehicle, wherein the respective VAs can perform their respective tasks simultaneously, substantially simultaneously, or in parallel. In some embodiments, one VA (e.g., VA 102) can perform multiple tasks simultaneously, substantially simultaneously, or in parallel. For example, with regard to the vehicle accident example, one VA (e.g., VA 102) can perform two or more of the aforementioned tasks (e.g., contact and interact with EMS or other medical personnel, contact and interact with the insurance company, contact and interact with law enforcement, and/or contact and interact with the towing company).

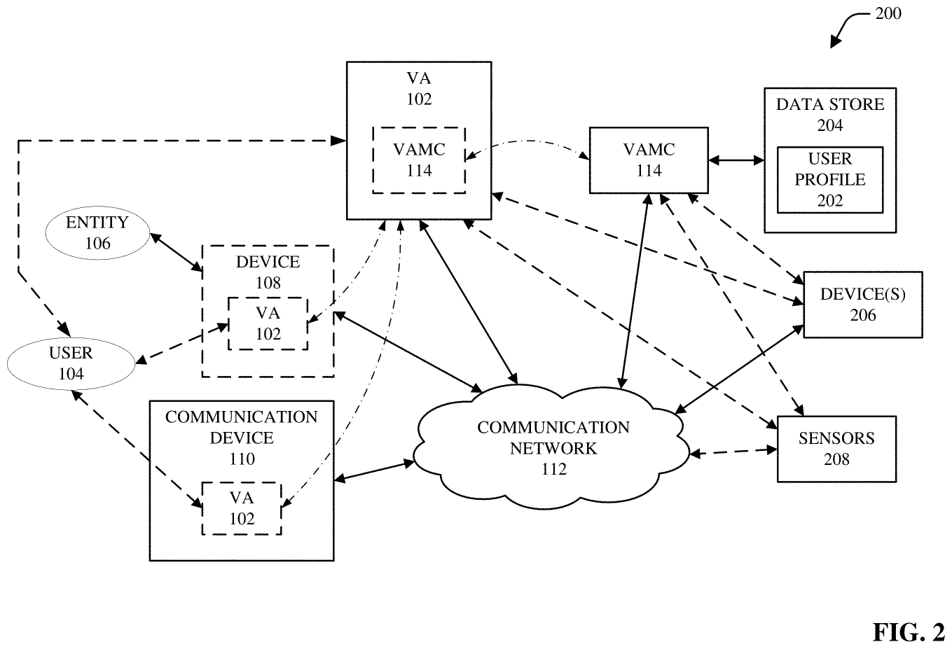

Other aspects and embodiments of the disclosed subject matter will be described with regard to the other figures (and/or FIG. 1). Referring to FIG. 2 (along with FIG. 1), FIG. 2 depicts a diagram of an example system 200 that can overlay VA personality attributes of a VA onto an interaction between the VA and a user to facilitate managing the VA during the interaction, in accordance with various aspects and embodiments of the disclosed subject matter. The system 200 can be employed, for example, in connection with an event with regard to which the user 104 engages and interacts with the VA 102.

The user 104 can engage with the VA 102 with regard to a desired unspecified task (e.g., support, automation, appointment, . . . ). The VAMC 114 of or associated with the VA 102 can retrieve a user profile 202 of the user 104 from the data store 204, wherein the user profile can comprise user-related information, including information relating personality attributes of the user 104, that was obtained from previous interactions between the VA 102 (or another VA(s)) and the user 104. In some embodiments, the VAMC 114 can retrieve the user profile 202 of the user 104 from the data store 204 via trusted identification (ID) tokens that can enable or grant authority to the VAMC 114 and associated VA 102 to access and/or update the user profile 202 of the user 104.

The VAMC 114 also can determine a list of possible output mechanisms or interfaces (e.g., audio speakers, display screen(s), and/or social feed, etc., mechanisms or interfaces) that can be utilized by the VA 102 to interact with the user 104 based at least in part on the information in the user profile 202 of the user 104 and/or the available mechanisms or interfaces of the particular device(s) through which the VA 102 is interacting with the user 104. For example, in some instances, one type of device through which the VA 102 can be interacting with the user 104 can comprise audio speakers through which the VA 102 can present verbal words of the VA 102 and/or other audio content to the user 104, a display screen though which the VA 102 can present visual information (e.g., visual images, video, . . . ) to the user 104, whereas, in other instances, another type of device through which the VA 102 can be interacting with the user 104 can comprise audio speakers through which the VA 102 can present verbal words of the VA 102 and/or other audio content to the user 104, but does not include a display screen. The VAMC 114 can determine the available mechanisms or interfaces of the particular device(s) through which the VA 102 is going to be interacting with the user 104 during the interaction. Based at least in part on knowing the available mechanisms or interfaces of the particular device(s), the VAMC 114 can manage (e.g., control) how the VA 102 interacts with the user 104 (e.g., can control which output mechanism(s) or interface(s) of the particular device(s) the VA 102 is going to use to interact with the user 104 at various times during the interaction). As another example, if the user 104 is interacting with a social feed of a social network via a device (e.g., communication device 110, device 108, . . . ), the VAMC 114 can determine that the social feed is a potential output interface or mechanism that can be used to interact with the user 104.

In some embodiments, as desired (e.g., optionally), the VAMC 114 can track and mine social interactions of the user 104 to determine typical sentiment (e.g., comical, happy, sad, or reserved, etc.) or personality attributes to enable the VAMC 114 to begin a determination of the personality attributes of the user 104. For instance, the VAMC 114 can track and mine social interactions of the user 104 with regard to social networking or feeds of the user 104, interactions of the user 104 with other people (e.g., other people in the room with the user 104, a phone conversation between the user 104 and another person), etc., to facilitate a determination of the personality attributes of the user 104.

In other embodiments, as desired, the VAMC 114 can track and mine content preferences of the user 104 to facilitate determining links to microgenres within a category with regard to interests of the user 104. For example, the VAMC 114 can track or mine content preferences of the user 104 to facilitate determining the categories of content (e.g., comedy movies, comedy television shows, drama movies, drama television shows, . . . ) of interest to the user 104 as well as microgenres within a category (e.g., preferred or favorite comedian, preferred or favorite actor, . . . ) of interest to the user 104. The VAMC 114 can utilize such information relating to determining categories of interest, and microgenres of interest, to the user 104 to facilitate determining personality attributes or sentiment of the user 104 and/or determining a type of response by the VA 102 during interaction with the user 104 (e.g., a response by the VA 102 that relates to a category of interest, or a microgenre of interest, to the user 104). For instance, if the VAMC 114 determines that a funny response or a joke in the voice of a preferred comedian of the user 104 can help to ease the aggravation of the user 104, which was detected or determined by the VAMC 114 during the interaction, the VAMC 114 can manage the VA 102 (e.g., manage or modulate the characteristics of the VA 102) to have the VA 102 present a funny response or a joke using the voice (e.g., by the VA 102 impersonating or emulating the voice) of the preferred comedian of the user 104.

In some embodiments, the VAMC 114 can manage the VA 102 to have celebrity voice or celebrity personality overlays for the VA 102 (e.g., a personal VA of the user 104), wherein the celebrity voice or celebrity personality overlays can be based at least in part on the preferences and/or personality attributes of the user 104, as indicated by the user 104 and/or learned or determined by the VAMC 114, and as stored in the user profile 202 of the user 104. In certain instances, such as when the VAMC 114 determines that the sentiment of the user 104 and/or context of the user 104 or interaction indicates that a lighter and/or comedic tone can or should be used when having the VA 102 communicate with the user 104, the VAMC 114 can control the characteristics (e.g., pitch, tone, cadence, inflection, etc.) of the voice and/or personality of the VA 102 to have the VA 102 impersonate or emulate a celebrity voice and/or personality when communicating information (e.g., verbal words) to the user 104. For example, if the user 104 is ordering tickets to a comedy club to see a particular comedian, the VAMC 114 can control the characteristics of the voice and personality of the VA 102 to impersonate or emulate (e.g., temporarily impersonate or emulate) the voice and personality of the particular comedian, and/or to present certain jokes or comedy pieces of the particular comedian, as the VA 102 is performing actions for the user 104 to order tickets to the comedy club for the user 104. In some instances, even if the user preferences of the user 104 typically do not indicate a certain celebrity voice or personality as being particularly preferred by the user 104, the VAMC 114 can determine that controlling the characteristics of or associated with the voice and/or personality attributes of the VA 102 to have the VA 102 temporarily impersonate or emulate the voice and personality of the certain celebrity under the circumstances, for example, based at least in part on the current sentiment and/or currently exhibited personality attributes of the user 104. That is, the VA 102 can temporarily switch the voice it uses to communicate with the user 104 to impersonate or emulate a desired celebrity voice or personality.

The VAMC 114 can determine or infer the sentiment and personality attributes of the user 104 based at least in part on the results of analyzing the information in the user profile, information relating to the initial interaction of the user 104 at the beginning of the interaction between the VA 102 and the user 104, and/or information relating to interaction of the user 104 that occurred prior to the VA 102 entering the interaction (e.g., as obtained or tracked by the VA 102 and/or VAMC 114). For instance, the VAMC 114 can analyze the dialog (e.g., hints in the dialog) between the VA 102 and user 104, and/or direct workflow or business logic associated with the user 104 and/or event (e.g., workflow or business with which the user 104 is engaging or having an issue, and/or which caused the user 104 to interact with the VA 102), the VAMC 114 can determine or infer the context of the interaction or user 104, including the contextual action desires of the user 104.

The VAMC 114 also can analyze the voice of the user 104 (e.g., words spoken by and/or characteristics of the voice of the user 104) or direct workflow history associated with the user 104 and/or event, the VAMC 114 can determine, and thus, the VAMC 114 and VA 102 can know, the progress (or lack of progress) that has been made with regard to the work or event at issue, and the speed of the interaction of the user 104 (e.g., speed of the interaction of the user 104 with regard to the event or work prior to, or since, the beginning of the interaction between the VA 102 and user 104). The VAMC 114 can determine or infer the sentiment and personality attributes of the user 104 based at least in part on the results of analyzing the voice of the user 104 or direct workflow history associated with the user 104 and/or event.

In certain embodiments, the VAMC 114 can be associated with (e.g., communicatively connected to) another device(s) 206 (e.g., Internet-of-Things (IoT) device(s)) and/or sensors 208 (e.g., environmental sensors, biometric sensors, . . . ) located in the area (e.g., area where the user 104 is located). The VAMC 114 can monitor, track, and/or receive information relating to, for example, context of the user 104 (e.g., physical location, action, etc., of the user 104), time of day, environmental conditions associated with the environment where the user 104 is located, etc., wherein such information can be obtained from the other device(s) 206, the sensors 208, and/or sensors or interfaces (e.g., microphone(s), camera, . . . ) of the VA 102. The environmental information can comprise, for example, the temperature, humidity, precipitation, and/or other weather or room related conditions where the user 104 is located and/or background environment information (e.g., baby crying in the background, animal making noise, . . . ) identified in the background during the interaction with the user 104. As desired (e.g., optionally), based at least in part on the results of analyzing the information obtained from the other device(s) 206, sensors 208, and/or sensors or interfaces of the VA 102, the VAMC 114 also can determine gestures (e.g., hand, arm, or finger gestures or movements, facial gestures, . . . ) of the user 104, which can contribute to the VAMC 114 understanding and determining the sentiment of the user 104 during the interaction. The VAMC 114 can determine or infer the sentiment and/or personality attributes of the user 104, the context of the user 104 or interaction, and/or the environmental conditions associated with the user, based at least in part on the results of analyzing the information relating to the environmental conditions of the environment associated with the user 104 and/or the other information (e.g., user profile information, interaction information, voice of the user, workflow or business logic or history, . . . ) relating to the user 104, such as described herein.

Based at least in part on the context of the user 104 or interaction, the environmental conditions associated with the user 104, and/or the personality attributes and sentiments of the user 104, the VAMC 114 can determine VA personality attributes of the VA 102 that can be desirable (e.g., optimal, suitable, acceptable, or useful). The VA 102 can respond or react to the user 104 using the VA personality attributes, wherein the VAMC 114 can control the VA 102 as the VA 102 responds or reacts to the user 104 by managing, modulating, or modifying the characteristics of the VA 102 to enable the VA 102 to have and exhibit the desired VA personality attributes as it responds or reacts to the user 104. For instance, based at least in part on the VA personality attributes and associated characteristics of the VA 102, the VA 102 (e.g., as controlled by the VAMC 114) can alter or modulate its dialog states and/or behavior in line with the user profile of the user 104, sentiments and personality attributes of the user 104, context of the user 104 or interaction, and environmental conditions. With understanding of the sentiment of the user 104 during the interaction (e.g., a particular point in the interaction), the VA 102 can use an aligned response to react to the user 104 (e.g., react to something said by the user 104 and/or the determined sentiment of the user 104 at that time).

In some embodiments, the disclosed subject matter can enable increased or extended use of the VA personality attributes via other devices, such as certain IoT devices, that can include some of the functionality, even though such other devices do not include all of the functionality of the VA 102 or device 108. For instance, a relatively less complex IoT device (e.g., an IoT device that is not able to implement all of the functionality of the VA 102, and/or does not include all of the functionality of device 108), can still implement and convey certain and/or different functionality (e.g., as managed by the VAMC 114) to the user 104 and/or other persons. For example, a certain IoT device (e.g., and IoT doorbell) can have the ability to present audio content (e.g., via an audio speaker(s)), but not visual content (e.g., due to having no display screen), and can still present certain audio content (e.g., a silly song) to the user 104 and/or other persons (e.g., via a relatively limited implementation of the VA 102 via the certain IoT device), in accordance with at least some of the personality attributes (e.g., a comedic or funny attribute, and/or a music-interest attribute) of the user 104, even though the certain IOT device does not have the relatively higher functionality that the VA 102 and/or device 108 have.

As desired, the VA 102 (e.g., as managed by the VAMC 114) can alter its dialog states and/or behavior to bootstrap or explore different states (e.g., different dialog states), wherein, for example, the VA 102 can mirror the same state(s) (e.g., angry plus happy) of the user 104, reflect an inverse state (e.g., angry plus comforting, etc., and use each response of the user 104 exploration and response by the user 104 to such exploration as learning moments to enable the VA 102 and associated VAMC 114 to learn more regarding the personality attributes and sentiments of the user 104 to refine the personality attributes of the VA 102 and train the VA 102. In some embodiments, as desired, the VAMC 114 can collect and aggregate factual points from the user 104 for a desired analysis, such as, for example, a market analysis (e.g., a comparison, such as an angry comparison, to another vendor or product).

Based at least in part on the context of the user 104 or interaction, the environmental conditions associated with the user 104, and/or the personality attributes and sentiments of the user 104, in accordance with the determined VA personality attributes of the VA 102, the VAMC 114 can control the VA 102 to modulate or modify the characteristics of the VA 102 to have the VA alter, for example, the speaking rate, tone, inflection, cadence, or other characteristics of the verbal words presented by the VA 102 to the user 104 to express (e.g., convey) a desired (e.g., comedic, serious, jovial, . . . ) sentiment to the user 104. Additionally or alternatively, similarly, based at least in part on (e.g., as appropriate for) the context of the user 104 or interaction, the environmental conditions associated with the user 104, and/or the personality attributes and sentiments of the user 104, in accordance with the determined VA personality attributes of the VA 102, the VAMC 114 can control the VA 102 to have the VA 102 interject jokes, factual, and/or suggestions to same-domain content (e.g., products, services, actions, recommendations, . . . ).

In certain embodiments, when there are multiple output mechanisms or interfaces available to the VA 102 (e.g., either through the VA 102 itself or other devices associated with the VA 102), the VAMC 114 can control operation of the VA 102 to have the VA 102 present (e.g., display) information having desirably fine-grain detail to the user 104, more background information (e.g., background information that can provide additional context to the user 104 with regard to other information presented to the user 104 by the VA 102), and/or related content or even distracting content (e.g., when determined to be appropriate by the VAMC 114). For instance, in accordance with the VA personality attributes of the VA 102, the VA 102 can present an appropriate verbal response to the user 104 via audio speakers of or associated with the VA 102, and also can use an available display screen of or associated with the VA 102 to present visual information (e.g., additional or background information in visual form) to the user 104 to provide the user with other potentially relevant information.

In some embodiments, there can be multiple VAs, including VA 102 (and another VA(s) (not shown)), that can be vying for the same output mechanism or interface (e.g., audio or display interface). The VAMC 114 can control the multiple VAs, or respective VAMCs of the respective VAs can coordinate with each other to control the multiple VAs, to collaboratively weight the respective intentions with regard to responses to the user 104 via the output mechanism or interface (and/or other output mechanisms or interfaces) before execution of the one or more of the responses of the VAs to the user 104 to facilitate determining which VA(s) is (are) to execute a response(s) and/or the order of execution of responses by the VAs via the output mechanism or interface. The VAMC 114 can employ techniques or methods (e.g., weighting techniques or methods) that can resolve the respective desires (e.g., needs) or intentions of, and/or conflicts between, multiple VAs engaged in multiple VA interactions that are sharing a common resource (e.g., a common interface, such as a display screen or audio speakers, of a device). For example, the VAMC 114 can employ such techniques or methods to resolve the respective desires of or conflicts between respective VAs that each desire to set background content on a display screen of a device (e.g., 108, 110, or 206) or make a physical IoT device respond in different or divergent ways (e.g., one VA wants the IoT device to respond comically to the user 104, and another VA wants the IoT device to respond aggressively to the user 104).

In certain embodiments, based at least in part on the context, environmental conditions, and/or personality attributes or sentiment of the user 104, the VAMC 114 can control the VA 102 to have the VA present, or to interact with another device(s) 206 (e.g., IoT device(s)) to have the other device(s) 206 present, desired content (e.g., display visual content, present audio content) or perform another desired action to facilitate modifying the state or engagement of the background environment associated with the user 104 to enhance the interaction with the user 104, enhance the user experience of the user 104, etc., in accordance with the defined VA management criteria. For example, the VAMC 114 can control the VA 102 to have the VA present, or to interact with the other device(s) 206 to have it present desired content or perform another desired action to distract a baby that is crying or agitated, to lower the blinds for privacy of the user 104, to temporarily disable a loud washing machine that is determined or perceived to be distracting to the user 104 or other person (e.g., the baby), or to perform or achieve another desired action or outcome.

As desired (e.g., optionally), the VA 102 (e.g., as managed by the VAMC 114) also can begin to explore alternate workflow planning with respect to the interaction and the user 104. For example, the VA 102 (e.g., as managed by the VAMC 114) determine a product or service recommendation for a product or service that can be useful to the user 104 based at least in part on the context of the user 104 or interaction, environmental conditions associated with the user 104, and/or sentiment and personality attributes of the user 104. Employing natural language understanding (NLU), the VAMC 114 and/or VA 102 can semantically link problems from the Internet to a service level agreement and can propose an alternate product or service that can better suit the user 104.

Further, the techniques utilized by the VAMC 114 and VA 102 can go beyond vocabulary and sentiment (e.g., user sentiment) alone to facilitate altering the behaviors of users (e.g., user 104), for example, for marketing to users, upselling products or services to users, recommending alternate products or services to users, etc., which can support an alternate function(s) with regard to which the respective users had not entered into their respective interactions with respective VAs. A VA 102 (e.g., as managed by the VAMC 114) can basically act as part robot therapist and part camp counselor. As another example, during an interaction by the VA 102 with the user 104, where the user 104 is purchasing, or considering purchasing, a good or service, the VA 102 can play music by a favorite band of the user 104 as background music to facilitate putting the user 104 in a better frame of mind to complete the purchase of the good or service, or even purchase another good or service. As still another example, during an interaction by the VA 102 with the user 104 (e.g., interaction relating to a product or service purchase or other type of interaction), the VA 102 or VAMC 114 can determine advertising (e.g., advertising for a particular product or service) that is considered particularly (e.g., highly) relevant and/or personalized to the user 104, and the VA 102 can present such relevant and/or personalized advertising to the user 104. The VA 102 and/or VAMC 114 also can collect information regarding the user 104 that the VAMC 114 can use to determine, understand, or recognize certain advertising that can be particularly relevant to the user 104, without the VAMC 114 or VA 102 actually producing or presenting such advertising to the user 104, wherein the VA 102 or VAMC 114 can provide information regarding such certain advertising in relation to the user 104 to another entity or device that can utilize the information regarding such certain advertising to interact with the user 104 (e.g., to advertise or promote a certain product or service to the user 104).

The VA 102 (e.g., as managed by the VAMC 114) also can determine and recommend alternate functionality to the user 104. For instance, based at least in part on the context of the user 104 or interaction, environmental conditions associated with the user 104, and/or sentiment and personality attributes of the user 104, the VAMC 114 and/or VA 102 can employ or reuse the context of the user 104 or interaction to determine, present, and propose (e.g., recommend) an alternate setting or process change to engage and/or inspire novelty of the user 104. For example, based at least in part on the context of the user 104 or interaction, environmental conditions associated with the user 104, and/or sentiment and personality attributes of the user 104, the VAMC 114 can determine that such alternate setting or process change can enhance, or at least is sufficiently likely to enhance, the novelty, perspective, workflow, and/or performance of the user 104. The VAMC 114 can control the operation of the VA 102 to have the VA 102 to present or propose (e.g., recommend) such alternate setting or process change to the user 104. The alternate setting or process change can be or can relate to, for example, a change in environment (e.g., determine, recommend, and/or take action to modify temperature in the room; have user 104 move to a different room or location; close a window or have the user 104 close the window to block out outside noise; . . . ), a change in a process of performing work (e.g., determine, recommend, and/or take action to enable the user 104 to use a second computer (e.g., laptop computer) as a second monitor along with the monitor of the desktop computer to make it easier for the user 104 to look at multiple documents or other content; have the user 104 perform work tasks of the work process in a different order or way to make it easier for the user 104 to perform the work tasks; indicate a different way for the user 104 to perform a work task when the VA 102 determines that the user 104 is having a problem performing the work task; . . . ), or another desired alternate setting or process change.

In some embodiments, the VAMC 114 and/or VA 102 can perform passive workflow entry to enhance the performance of the user 104 with regard to workflow or tasks of the user 104. For instance, based at least in part on the context of the user 104 or interaction, environmental conditions associated with the user 104, and/or sentiment and personality attributes of the user 104, the VAMC 114 can determine questions (e.g., subtle questions) or other responses, which can be in a same or similar workflow as that being engaged in by the user 104, wherein such questions or other responses can help stimulate the user 104 (e.g., stimulate the mind of the user 104) to facilitate solving, by the user 104, related problems regarding the workflow or tasks that the user 104 is performing or trying to perform. The VA 102 can present such questions or other responses to the user 104 to facilitate solving such related problems by the user 104.

The VAMC 114 also can utilize the learning (e.g., learning of personality attributes of users, learning of contexts of users and interactions, learning regarding various topics, . . . ) of the VAMC 114, VAs (e.g., VA 102), and users (e.g., user 104) for various topics and how to properly respond to users (e.g., proper, optimal, or otherwise desirable dialog states and engagement attributes, the VAMC 114 can summarize and propose (e.g., to users, such as user 104), for example, as post-mortem training or management, recommendations (e.g., suggestions) for subsequent management review or workflow alteration.

As desired (e.g., optionally), the VAMC 114 can control the operation of the VA 102 to socially emulate the user 104. For instance, the VAMC 114 and VA 102 can monitor the responses and actions of the user 104 to determine the respective importance or significance of various social entities or connections (e.g., child, animal, friend, etc., of the user 104). The VAMC 114 can learn questions or VA responses regarding these social entities or connections that can be desirable (e.g., optimal, useful, or appropriate) to present (e.g., by the VA 102) to the user 104 to help enhance the sentiment (e.g., mood) of the user 104 (e.g., help defray negative sentiment of the user 104, in response to determining that the user 104 has such negative sentiment) and/or mine for (for presentation of) additional recommendation points (e.g., suggestions) that can enhance the user experience of the user 104 (e.g., based at least in part on the personality attributes and sentiment of the user 104).

The VAMC 114 also can update the user profile 202 of the user 104 based at least in part on, and/or to include, the results of tracking the interaction between the user 104 and VA 102, dialog statement and engagement attribute preferences determined with respect to the user 104 (e.g., learned or determined from the interaction), personality attributes and sentiments (or updates to personality attributes or sentiments) of the user 104 learned from the interaction between the user 104 and VA 102, outcome of the interaction between the user 104 and VA 102, etc. The VAMC 114 can store the user profile 202 (e.g., updated user profile) of the user 104, as updated, in the data store 204. The VAMC 114, VA 102, another VAMC, VA, and/or other component or device can utilize the updated user profile of the user 104 during a future interaction with the user 104 to facilitate desirable (e g, enhanced, optimal, or suitable) interaction with the user 104 during the future interaction.

In some embodiments, if the VAMC 114 is remote from the VA 102 and manages the VA 102 (e.g., VAMC 114 provides a central management service that can manage the VA 102), and connectivity between the VA 102 and VAMC 114 is not available for a period of time or is otherwise not suitable (e.g., poor connectivity between the VA 102 and VAMC 114), the VA 102 can continue to operate to interact with the user 104 (and/or other users, VAs, devices, or entities), wherein the VA 102 can have virtually full functionality (e.g., almost the same functionality as when the VA 102 is connected to the VAMC 114), such as more fully described herein, or at least limited functionality (e.g., a portion of its full functionality), that can be utilized to interact with the user 104 (and/or other users, VAs, devices, or entities). In certain embodiments, the VA 102 can comprise or be associated with a local VAMC that can perform all, virtually all, or at least a desirable portion of the functions (e.g., VA management functions, data analysis functions, operational functions, . . . ) that the VAMC 114 can perform, as more fully described herein, and can manage operation of the VA 102 in a same or similar manner that the VAMC 114 can manage the VA 102, for example, when the VAMC 114 is not connected to the VA 102, and/or can coordinate and/or share management of the VA 102 with the VAMC 114 when the VAMC 114 is connected to the VA 102.

During the time that the VA 102 is operating using the local VAMC (e.g., when the VAMC 114 is not connected, or at least not suitably connected, to the VA 102), the local VAMC can monitor an interaction between the VA 102 and user 104 (and/or other users, VAs, devices, or entities), and can collect and store (e.g., in a data store) information relating or relevant to the interaction (e.g., dialog of the interaction, sensor data, or other desired information). The local VAMC can utilize and analyze such information to determine how to manage, and to manage, operation of the VA 102 during the interaction in a same or similar manner as the VAMC 114 can manage the VA 102 when connected to the VAMC 114, as more fully described herein.

When the VA 102 is able to connect (e.g., suitably connect) with the VAMC 114, the local VAMC can synchronize with the VAMC 114 to exchange information with the VAMC 114, including the information relating or relevant to the interaction (or any other interaction associated with the VA 102) during the time when the VA 102 and VAMC 114 were not connected, and/or other information that the VAMC 114 desires to communicate to the VA 102 or local VAMC. For example, as part of the local VAMC synchronizing with the VAMC 114, the local VAMC can communicate, to the VAMC 114, information regarding dialog that occurred (e.g., between the user 104 and VA 102) during the interaction, sensor data collected by the VA 102 or local VAMC, analysis data or results (e.g., analysis data or results from data analysis performed by the local VAMC or VA 102), user sentiment, user personality attributes, VA personality attributes, and/or environmental conditions, etc.

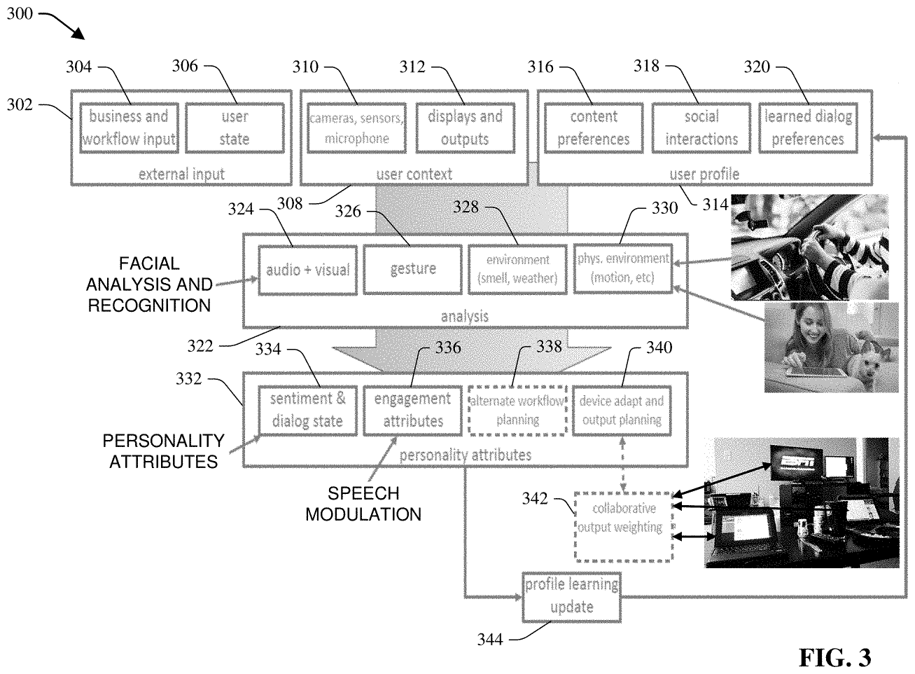

Referring to FIG. 3 (along with FIG. 1), FIG. 3 presents a diagram of an example overlay of VA personality attributes onto an interaction and associated process 300 with regard to an interaction between a VA and a user to facilitate managing the VA during the interaction, in accordance with various aspects and embodiments of the disclosed subject matter. The example overlay of VA personality attributes onto an interaction and associated process 300 can relate to, for example, an event with regard to which the user 104 engages and interacts with the VA 102.

The user 104 can engage with the VA 102 with regard to a desired unspecified task (e.g., support, automation, appointment, . . . ). The VAMC 114 of or associated with the VA 102 can retrieve a user profile of the user 104 from the data store (e.g., 204), wherein the user profile can comprise user-related information, including information relating to personality attributes, preferences, personal interests, family/relatives, social interactions, friends, demographics, and/or communication devices (e.g., communication device 110 or other communication device(s)) of or associated with the user 104.

The VAMC 114 can monitor, track, and/or receive various types of information relating to the user 104 from various sources (e.g., VA 102, device 108, communication device 110, other device(s) 206 (e.g., IoT device(s)), sensors 208, etc.). For instance, the VAMC 114 can receive external inputs 302, such as business and workflow input information 304 regarding the business or workflow currently engaged in by the user 104 and/or user state information 306 relating to the current user state and/or sentiment of the user.

The VAMC 114 also can obtain information relating to the user context 308 of the user 104 from various sources, such as, for example, cameras (e.g., camera(s) of the communication device 110, device 108, or other device 206), sensors (e.g., sensors 208 or other sensors associated with device(s) 108, 110, or 206), and/or microphones (e.g., microphone(s) of the communication device 110, device 108, or other device 206), etc., 310 and/or displays (e.g., display screens) or other outputs 312 associated with one or more devices (e.g., 108, 110, or 206) associated with the user 104. For instance, the VAMC 114 can obtain information regarding the facial expressions of the user 104 during the interaction, body gestures of the user 104 during the interaction, vocal expressions (e.g., speech, sounds, . . . ) of the user 104 during the interaction, other sounds associated with the user 104 (e.g., sounds in the background environment). The VAMC 114 also can receive information regarding what is be displayed or otherwise output by the communication device 110 of the user, device 108, and/or other device(s) 206 (e.g., IoT device(s), television, or radio, . . . ).

The VAMC 114 also can retrieve the user profile 314 associated with the user 104 from the data store (e.g., data store 204). The user profile 314 can comprise various types of information (e.g., user-related information) relating to the user 104, such as content preferences 316 that can indicate music, video, television, movie, or other content preferences of the user 104, social interactions 318 of the user 104 (e.g., family/relatives, friends, social networking activity, . . . , associated with the user 104), and/or learned dialog preferences 320 of the user 104. The user profile 314 also can comprise other user-related information, such as information relating to personality attributes, other personal interests, other preferences, demographics, and/or communication devices (e.g., communication device 110 or other communication device(s)) of or associated with the user 104. The learned dialog preferences 320 can relate to, for example, the various types of dialog the user 104 often engages in (e.g., business or professional style of dialog; joking, jovial, witty, or funny style of dialog; sarcastic style of dialog; . . . ) under various conditions (e.g., situations, problems, . . . ) and/or various types of dialog that the VA 102 has used or can use when conversing with the user 104 under various conditions, as learned by the VAMC 114 over time, wherein the various types of dialog, which the VA 102 has used or can use when conversing with the user 104, can include types of dialog that have been effective or useful when conversing with the user 104 to achieve a desirable (e g, enhanced, optimal, suitable, or acceptable) user experience and/or outcome for the user 104.

The VAMC 114 can perform an analysis 322 on the various items of information tracked or obtained by the VAMC 114 with regard to, for example, the external input 302, user context 308, user profile 314, and/or other sources. As part of the analysis 322, the VAMC 114 can perform an audio and/or visual analysis 324 on audio or visual information associated with the user 104. For example, the VAMC 114 can perform an audio analysis on the voice of the user 104 (or another voice(s) of another person(s) in the background) to facilitate determining what the user 104 (or other person(s)) said, characteristics (e.g., tone, cadence, timbre, volume, language, dialect, vocabulary level, . . . ) of the voice of the user 104 (or voice(s) of the other person(s)). The VAMC 114 also can perform an audio analysis on any other types of background noises (e.g., television is presenting a particular program; radio is presenting a certain song; washing machine is on; vehicles are moving; or emergency vehicle siren is being emitted; . . . ) to facilitate determining what is going on in the background associated with the user 104. The VAMC 114 also can perform a visual analysis of any images of the user 104 to facilitate determine the facial and other body (e.g., hand, arm, . . . ) gestures 326 of the user 104, or other characteristics (e.g., bleeding cut on body) of the user 104 to facilitate determining the context and/or sentiment of the user 104. The visual analysis performed by the VAMC 114 also can include a visual analysis of the environment 328 (as well as audio analysis of the environment 328) where the user 104 is located to facilitate determining the physical environment 330, and features of the physical environment 330, where the user 104 is (e.g., in the car; at home; which room in the home; at the office; at a restaurant; . . . ), motion or other physical activity of the user 104 (e.g., user 104 is driving; user 104 is holding a cup or communication device 110 in one hand; user 104 is holding a book or electronic tablet; user 104 is holding or using a remote control for the television or other device; . . . ), and the environmental conditions (e.g., sunny or cloudy outside; raining outside; time of day (e.g., daytime, dawn, sunset, or nighttime); . . . ) of the environment 328 associated with the user 104. Such analysis results can be used to facilitate determining the context and/or sentiment of the user 104. Other analyses can be performed on the available information relating to the user 104 to determine other relevant features, such as, for example, weather conditions (e.g., temperature, barometric pressure), air quality (e.g., pollution index, allergen index, . . . ), smells (e.g., food cooking, pollution smells, smell of something burning, . . . ) of the environment 328. These other types of analysis results also can be used to facilitate determining the context and/or sentiment of the user 104.

Based at least in part on the results of the analysis 322 of the various items of information associated with the user 104, the VAMC 114 can determine the sentiment and personality attributes 332 of the user 104. For instance, based at least in part on the results of the analysis 322, the VAMC 114 can determine the sentiment (e.g., attitude, mood, or view, . . . ) and dialog state 334 of the user 104 during the interaction (e.g., respective sentiments and dialog states 334 of the user 104 at respective times during the interaction). The dialog state can relate to a status (e.g., current status) of the dialog between the user 104 and the VA 102 (or other VA or entity, when the other VA or entity was previously part of the interaction), wherein the dialog state can include a determination or indication regarding an amount of progress in solving a particular problem or dealing with a particular situation. The sentiment and dialog state 334 also can indicate whether the user 104 has been determined (e.g., by the VAMC 114) to be active, outgoing, passive, reserved, task oriented, or people oriented.

Based at least in part on the results of the analysis 322 and/or the determination of the sentiment and dialog state 334, the VAMC 114 can determine or measure engagement attributes 336 relating to the engagement of the user 104 with the VA 102. The engagement attributes 336 can include the speech modulation or other characteristics of the verbal words presented by the VA 102 to the user 104 during the interaction. For example, based at least in part on the results of the analysis 322 and/or the determination of the sentiment and dialog state 334, the VAMC 114 can determine modifications to the speech modulation or other characteristics of the verbal words presented by the VA 102 to the user 104 during the interaction that can enhance the progress of the interaction to achieve a desired goal of the interaction, and can control the VA 102 by implementing the modifications to the speech modulation or other characteristics of the verbal words presented by the VA 102 to the user 104.

The engagement attributes 336 also can comprise, for example, the focused attention of the user 104, wherein the VAMC 114 can determine or measure the level or extent of focused attention of the user 104 while interacting with the VA 102. The engagement attributes 336 also can include, for example, novelty of the interaction with respect to the user 104, wherein the VAMC 114 can determine or measure the novelty of the interaction, as experienced by the user 104 (e.g., Is the VA 102 presenting the user 104 new or novel information?; Is the VA 102 presenting the user 104 new or novel features?; How is the user 104 reacting to the new or novel information, or the new or novel features?; . . . ). The engagement attributes 336 further can comprise one or more other types of engagement attributes (e.g., aesthetics appeal, endurability, positive affect, reputation, trust, or expectation, etc., as experienced by the user 104, with respect to the engagement of the user 104 with the VA 102).

Also, based at least in part on the results of the analysis 322 and/or the determination of the sentiment and dialog state 334, the VAMC 114 can determine (e.g., optionally can determine) an alternate workflow planning 338 for the user 104, for example, when workflow planning is pertinent to the interaction between the user 104 and the VA 102. For example, if the VA 102 is engaged by the user 104 with respect to a work project or task (e.g., to obtain assistance on the work project or task from the VA 102), the VAMC 114 can determine an alternate workflow planning 338, which can include a set of activities, tasks, or steps that can be performed by the user 104, the VA 102, or another entity or device, to achieve the desired goal (e.g., desirable (e.g., optimal, enhanced, or acceptable) completion of the work project or task), based at least in part on the results of the analysis 322 and/or the determination of the sentiment and dialog state 334.

In some embodiments, based at least in part on the results of the analysis 322 and/or the determination of the sentiment and dialog state 334, the VAMC 114 can determine device adaptation and output planning 340 to adapt a device that is implementing the VA 102 to present information to the user 104 via the device, determine which output interfaces or other resources of the device are available for use to present the information to the user 104, and/or determine which output interface(s) or other resources of the device are to be used by the VA 102 to present the information to the user 104 (e.g., to achieve desired progress towards a desired goal during the interaction and/or to enhance the user experience of the user 104 during the interaction). The VA 102 (e.g., as managed by the VAMC 114) can implement the device adaptation and output planning 340, and can present the information to the user 104 via the output interface(s), and/or using the other resources, of the device, in accordance with the device adaptation and output planning 340.

For instance, the VAMC 114 can determine what output interfaces (e.g., display screen, speakers, or haptic feedback component, . . . ) and/or other resources (e.g., processing resources, media (e.g., music, video, pictures), . . . ) are available on or through the device(s) (e.g., communication device) through which the VA 102 is communicating with the user 104. The VAMC 114 can determine how the VA 102 is to interact with the user 104, including determining which output interface(s) and/or other resources of the device(s) that are to be used to interact with the user 104, and facilitate adapting the device(s) accordingly, based at least in part on the results of the analysis 322, including the sentiment and personality attributes of the user 104, and the results of determining what output interfaces and/or other resources are available on or through the device(s). As an example, based at least in part on the sentiment (e.g., sad) and personality attributes (e.g., personality attributes that include caring and sentimental) of the user 104, a display screen and speakers being available on the device through which the VA 102 is interacting with the user 104, and pictures of the children of the user 104 being stored in the device, the VAMC 114 can determine that, while the VA 102 is conversing with the user 104 via the speakers of the device, happy pictures of the children and/or the user 104 are to be presented to the user 104 via the display screen of the device to attempt to reduce the state of sadness of the user 104, and can facilitate adapting the VA 102 and device accordingly.

In certain embodiments, if there are multiple devices through which the VA 102 can interact with the user 104 or if there are multiple VAs are attempting to interact with the user 104 or another user and are attempting to utilize the same output interface of a device or same other resources, as part of the device adaptation and output planning 340, the VAMC 114 can perform (e.g., optionally can perform, prior to execution by the VA(s)) collaborative output weighting 342 to collaboratively weight the respective intended interactions of the respective VAs with the user 104 and/or other user to determine which VA is to utilize a particular output interface of the device when more than one VA is intending to use the particular output interface to interact with the user 104 and/or other user, and/or to determine which of multiple devices the VA 102 is to utilize to interact with the user if there are multiple devices available through which the VA 102 can interact with the user 104. For instance, if the VA 102 is desiring to interact with the user 104 through a particular output interface (e.g., display screen) of a device, and a second VA also is desiring to interact with the user 104 through that particular output interface, the VAMC 114 can collaboratively weight the respective intentions to interact with the user 104 by the respective VAs to determine which VA(s) is (are) to execute the interaction(s) with the user 104 via the particular output interface and/or the order of execution of respective interactions by the respective VAs via the particular output interface, in accordance with the defined VA management criteria. The VAs can be controlled (e.g., by the VAMC 114) to execute the interaction of the VA 102 and/or the other interaction of the other VA according to the results of the collaborative output weighting 342. For example, based at least in part on the results of the analysis 322, the sentiment and personality attributes of the user 104, and the respective intended interactions of the VA 102 and the other VA via the particular output interface, the VAMC 114 can determine that it can be more beneficial to the user 104 to have the VA 102 execute its intended interaction with the user 104 before the other intended interaction of the other VA with the user 104, and accordingly, the VAMC 114 can weight the intended interaction of the VA 102 higher than the other intended interaction of the other VA. Accordingly, the VAMC 114 can determine that the intended interaction of the VA 102 with the user 104 is to be executed via the particular output interface instead of, or before, the execution of the other intended interaction of the other VA with the user 104 via the particular output interface.

Based at least in part on the results of the analysis 322, the determination of the personality attributes 332 of the user 104, and/or the results of the current interaction (or portion thereof) of the VA 102 with the user 104, the VAMC 114 can determine a profile learning update 344 that can be made to the user profile 314 of the user 104, and can update the user profile 314 based at least in part on the profile learning update 344, wherein the updated user profile 314 can be stored in the data store (e.g., 204) for future use during the current interaction (if still in progress) or a future interaction with the user 104. For instance, the VAMC 114 can determine a profile learning update 344 that can include the results of the analysis 322, information comprising or relating to the dialog or other interaction between the VA 102 and user 104 during the interaction session, any new personality attributes, or updates or refinements of known personality attributes, of the user 104 learned or determined during the interaction between the VA 102 and user 104, the sentiment(s) and user context(s) of the user 104 during the interaction, the modulations or modification of characteristics of the VA 102 made during the interaction (e.g., in relation to the sentiment(s), user context(s), and personality attributes of the user 104), engagement attribute preferences regarding the user 104 that were learned or determined during the interaction, the results of any probing or learning with respect to the user 104 that was performed by the VA 102 during the interaction to learn more about the user 104 (e.g., learn more about the personality of the user), the actions taken by the VA 102 (e.g., in relation to the sentiment(s) or context(s) of the user 104) during the interaction, the device(s) and/or output mechanism(s), output interface(s), or other device resource(s) utilized by the VA 102 during the interaction, and/or the results of the interaction (e.g., how successful was the interaction, was the desired goal of the interaction achieved, . . . ). The user profile 314 (as updated) of the user 104 can be utilized by the VAMC 114 or other VAMC, and/or the VA 102 or other VA, during future interaction with the user 104.

Another set of examples (e.g., respective examples of respective users) can illustrate how the VA 102 (e.g., as managed by the VAMC 114) can be adapted (e.g., can adapt the VA personality attributes and responses of the VA 102) to respectively interact with respective users, in accordance with the defined VA management criteria. The respective examples of respective users can relate to when the respective users (e.g., respective customers) engage (e.g., call in to) the VA 102 because their respective service levels of the services provided to the respective users have been depleted, wherein, in each example case, the user can be determined to be somewhat irritated regarding, at least, the depletion of their respective services.

In the first example instance, the user 104 can call in and be connected to the VA 102, wherein the user 104 can be somewhat irritated because the previous service level of the service provided to the user 104 has been depleted. The VAMC 114 can identify the user profile (e.g., user profile 202) of the user 104, and retrieve the user profile of the user 104 from the data store (e.g., data store 204). The VAMC 114 can load the user profile of the user 104 into, or otherwise provide the user profile to, the VA 102. From the user profile of the user 104, the VA 102 (and/or the VAMC 114) can determine that the user 104 has personality attributes that indicate that the user 104 is cautious and slightly sarcastic in nature. Based at least in part on the user profile of the user 104 (e.g., and accordingly determining that the user 104 is cautious and slightly sarcastic in nature) and determining that the user 104 is slightly irritated, the VA 102 can be controlled (e.g., by the VAMC 114) to have characteristics, and correspondingly, VA personality attributes, that can mirror and/or emulate the cautious and slightly sarcastic nature of the user 104, and to detect the sentiment (e.g., slightly irritated) of the user 104. In response to detecting the slight irritation and/or frustration of the user 104, the VA 102 (e.g., as managed by the VAMC 114) can overlay into the communication device 110 of the user 104 that the user 104 used to call in, and can engage the user 104 in some initial voice conversation.

In response to the user 104 indicating that additional service or a change (e.g., upgrade) in service is desired by the user 104, and knowing the slightly sarcastic nature of the user 104, as well as the slightly irritated mood of the user 104, the VA 102 can respond with a somewhat sarcastic remark, such as, “Are you sure? You only did this once in the last year,” to reflect or mirror the slightly sarcastic nature of the user 104, wherein such response was determined (e.g., by the VAMC 114 or VA 102) to be the appropriate response, given the context, sentiment of the user 104, and personality attributes of the user 104.

The user 104 can respond to response of the VA 102. For instance, the user 104 can respond with a statement that can indicate to the VA 102 or VAMC 114 that the somewhat sarcastic remark of the VA 102 presented to the user 104 has been effective, at least somewhat effective, or at least not detrimental, to the interaction between the VA 102 and user 104. Based at least in part on such current sentiment of the user 104, personality attributes of the user 104, and context of the interaction, the VA 102 can accept the response of the user 104 and can present another response to the user 104 that can continue to contain a bit of sarcasm. For instance, the other response presented by the VA 102 to the user 104 can request that the user 104 authorize the additional service or upgrade to the service.

In this first example instance, in response, the user 104 can authorize the additional service or upgrade to the service, and, in doing so, can start to rant somewhat. The VA 102 can ask the user 104 for confirmation of the authorization for the additional service or upgrade to the service. Based at least in part on the results of analyzing the current sentiment of the user 104 (e.g., the rant of the user 104), other context of the interaction or user 104, and personality attributes of the user 104, the VAMC 114 can determine that the dialog state of the interaction (and, in particular, the user 104) indicates that the user 104 should not be interrupted during the user's rant. Accordingly, the VAMC 114 can manage the VA 102 to not have the VA 102 interrupt the user 104 as the user rants, but, in the meantime, the VA 102 can begin or continue execution of adding or upgrading service. Before finalizing the addition or upgrade of the service of the user 104, and after allowing the user 104 to engage in the rant for a while, the VA 102 can affirm the change to the service, or can re-confirm that the change to the service is authorized by the user 104, and the VA 102 can present positive and/or sarcastic dialog to end the conversation with the user 104 to facilitate ending the conversation with the user 104 on a desirable (e.g., suitable, optimal, or appropriate) note, in accordance with the sentiment and personality attributes of the user 104. It is to be appreciated and understood that the VA 102 (e.g., as managed by the VAMC 114) can express sarcasm (or other VA personality attributes) in a variety of ways, which can include verbal expression or non-verbal expression. For example, when the context, sentiment, and/or personality attributes of the user 104 indicate that a particular (e.g., non-verbal) sarcastic expression, response, or action by the VA 102 to the user 104 is appropriate, the VA 102 (e.g., as managed by the VAMC 114) can express sarcasm to the user 104 in non-verbal form by changing (e.g., initially changing) a channel on a television the user 104 is watching or a radio the user 104 is listening to present video or audio content to the user 104 that the VA 102 knows the user 104 does not like, rather than tell (or in addition to telling) the user 104 a sarcastic joke or make a sarcastic comment to the user 104.

In the second example instance, another user can call in and be connected to the VA 102, wherein the other user can be somewhat irritated because the previous service level of the service provided to the other user has been depleted. Thus, the situation of the other user with regard to service depletion can be same as or similar to the first example instance. The VAMC 114 can identify the user profile of the other user, and retrieve the user profile of the other user from the data store (e.g., data store 204). The VAMC 114 can load the user profile of the other user into, or otherwise provide the user profile to, the VA 102. From the user profile of the other user, the VA 102 (and/or the VAMC 114) can determine that the other user has personality attributes that indicate that the other user is jovial and adventuresome in nature. Based at least in part on the user profile of the other user (e.g., and accordingly determining that the other user is jovial and adventuresome in nature), the VA 102 can be controlled (e.g., by the VAMC 114) to have certain characteristics, and correspondingly, certain VA personality attributes, that can mirror and/or emulate the jovial and adventuresome nature of the other user, and to detect the sentiment (e.g., slightly irritated) of the other user. Further, based at least in part on the results of analyzing the interaction of the other user thus far in the interaction (e.g., by analyzing the other user's voice, facial features, and/or gestures, etc.), the VAMC 114 can determine the current context of the other user and/or interaction overall, the VAMC 114 can determine or detect that the other user is slightly irritated. The VAMC 114 also can analyze information relating to environmental conditions associated with the other user to determine the environmental conditions associated with the other user. In response to detecting the slight irritation and/or frustration of the other user, the VA 102 (e.g., as managed by the VAMC 114) can overlay into the communication device in the vehicle of the other user that the other user used to call in, and can engage the other user in some initial voice conversation.

The VAMC 114, and thus, the VA 102, can know or learn that the communication device in the vehicle has a display screen. Based at least in part on the current context (e.g., other user is slightly irritated), and the personality attributes of the other user, the VAMC 114 can determine that presenting (e.g., displaying) certain information on the display screen of the communication device, and giving a positive suggestion (e.g., suggestion regarding service, such as a service upgrade) to the other user, can or may help to alleviate the irritation that the other user is experiencing. Accordingly, the VAMC 114 can control the VA 102 to have the VA 102 display, on the display screen of the communication device, a bar chart containing historical results regarding the service the other user has had, and also can display, on the display screen of the communication device, warm (e.g., emotionally warm) pictures of the other user's family or a recent outing of the other user (e.g., a recent outing with friends). The VAMC 114 also can control the VA 102 to have the VA 102 present (e.g., via verbal words) to the other user that give the other user a positive suggestion (e.g., suggestion regarding service, such as a service upgrade).

The interaction can continue as the other user converses with the VA 102, indicating the needs (e.g., service needs) for the other user's family, and thus, indicates a desire to change (e.g., upgrade) the service. The VA 102 can ask the other user about any recent life changes in the other user's life (e.g., whether there has been a change in employment, income, residence; whether there has been a change in the family, such as a new baby, a marriage, a divorce, etc.; or other life changes). The VA 102 (e.g., as managed by the VAMC 114) can update the user profile of the other user to include the life changes in the life of the other user. Based at least in part on the recent life changes of the other user and the other user's personality attributes, the VAMC 114 also can determine an update to the media (e.g., songs, podcasts, audio books, video, terrestrial or satellite radio channels, favorite radio channels, etc.) that can be available to the communication device (or other communication device(s)) in the vehicle of the other user, and, accordingly, the VA 102 can perform an update to the media that can be available, or at least most readily available, to the communication device (or other communication device(s)) in the vehicle of the other user.

In accordance with the other user's personality attributes, and the VA personality attributes, the VA 102 (e.g., as managed by the VAMC 114) can continue to converse (e.g., using verbal words) with the other user to give the other user affirmation of the other user's choice to change (e.g., upgrade) the service. While the VA 102 executes the service order to change the service of the other user (e.g., in a non-distracting background), the VA (e.g., as managed by the VAMC 114) can present cheery music to the other user via the audio interface (e.g., audio speakers) of the communication device in the vehicle of the other user, wherein the selection (e.g., song selection) and type (e.g., cheery) of music can be determined by the VAMC 114 in accordance with the sentiment, personality attributes, and musical interests of the other user.

After executing the service change, the VA 102 can converse with the other user to affirm the change in service with the other user. After affirming the change in service with the other user, the VA 102 can end the conversation with the other user.

Thus, as can be observed from the first and second example instances, with regard to the same or similar issue or situation (e.g., depletion of a service), the VA 102, as managed by the VAMC 114, can have different VA personality attributes and can respond differently to different users having different personality attributes. Further, the VA 102, as managed by the VAMC 114, can respond differently (e.g., using different responses and/or interfaces) across different types of communication devices associated with different users (or the same user).

In still other embodiments, an entire interaction (and exchanges of information), or a desired portion of the interaction, between one or more VAs (e.g., VA 102), one or more users (e.g., user 104) and/or one or more associated communication devices (e.g., communication device 110, device 108, or other device, such as an IoT device), and/or one or more other devices or entities can occur in a virtual reality (VR) and/or augmented reality (AR) setting(s). For example, instead of a real event setting (e.g., automobile accident, purchase of a product or service, social or business interaction, medical or health related event setting, or legal or law enforcement related event setting, . . . ), one or more users (e.g., user 104) can be interacting in a virtual environment (e.g., a VR and/or AR environment), such as a racing simulator, customer care or other training program, or other synthetic environment. With no loss or modification of functionality, the VAMC 114 can connect and manage the VA(s) (e.g., VA 102) during the interaction, based at least in part on (e.g., according to) the context(s) of the interaction (e.g., overall context of the interaction, which can include and/or be based at least in part on the user context(s) of the user(s), VA context(s) of the VA(s), communication device context(s) of the communication device(s), . . . ), environmental conditions (e.g., real or virtual environmental conditions) associated with the user(s), and personality attributes and sentiments of the user(s) (e.g., user 104), such as disclosed or described herein.

With further regard to the communication network 112 depicted in FIG. 1, a RAN of the communication network 112 can be associated with (e.g., connected to) or can comprise a core network (e.g., mobile core network) that can facilitate communications by communication devices (e.g., communication device 110, device 108, VA 102, . . . ) wirelessly connected to the communication network 112. A communication device (e.g., communication device 110, device 108, VA 102, IoT device, . . . ) can be communicatively connected to the core network via a base station. The core network can facilitate wireless communication of voice and data associated with communication devices associated with the communication network 112. The core network can facilitate routing voice and data communications between communication devices and/or other communication devices (e.g., phone, computer, VA, email server, multimedia server, audio server, video server, news server, financial or stock information server, other communication devices associated with an IP-based network (e.g., the Internet, an intranet, . . . ) (not shown in FIG. 1) associated with the communication network 112.

In accordance with various embodiments, the communication network 112 can comprise a macro communication network and/or a micro communication network. The macro communication network can be, can comprise, or can be associated with a core network, a cellular network, an IP-based network, Wi-Fi, gigabit wireless (Gi-Fi) network, Hi-Fi network (e.g., providing higher gigabit data communication than Gi-Fi or Wi-Fi), Bluetooth, ZigBee, etc. The micro communication network can be associated with the macro communication network, wherein the micro communication network typically can operate in a defined local area (e.g., in or in proximity to a home, building, or other defined area). The micro communication network can be, can comprise, or can be associated with Wi-Fi, Gi-Fi, Hi-Fi, Bluetooth, ZigBee, etc., and/or can be associated with (e.g., connected to) the macro communication network. The micro communication network can be or can comprise, for example a local area network (LAN), that can facilitate connecting certain devices (e.g., communication devices) associated with the micro communication network to each other and/or to the macro communication network.

Respective communication devices (e.g., communication device 110, device 108, VA 102, IoT device, . . . ) can be associated with (e.g., communicatively connected to) the communication network 112 via a wireless communication connection or a wireline (e.g., wired) communication connection (e.g., via a cell and associated base station). The respective communication devices can operate and communicate in a communication network environment. At various times, a communication device can be communicatively connected via a wireless communication connection(s) to one or more radio access networks (RANs), which can comprise one or more base stations to communicatively connect the communication device to the communication network 112 to enable the communication device to communicate other communication devices associated with (e.g., communicatively connected to) the communication network 112 in the communication network environment. The one or more RANs can comprise, for example, a 3GPP universal mobile telecommunication system (UMTS) terrestrial RAN (UTRAN), an E-UTRAN (e.g., Long Term Evolution (LTE) RAN), a GSM RAN (GRAN), and/or other type of RAN(s) employing another type of communication technology.

The communication network 112 can comprise one or more wireline communication networks and one or more wireless communication networks, wherein the one or more wireless communication networks can be based at least in part on one or more various types of communication technology or protocols, such as, for example, 3G, 4G, 5G, or x generation (xG) network, where x can be virtually any desired integer or real value; Wi-Fi; Gi-Fi; Hi-Fi; etc. The communication network 112 (e.g., a core network, cellular network, or a network comprising a core network, cellular network, and/or an IP-based network) can facilitate routing voice and data communications between a communication device(s) (e.g., communication device 110, device 108, VA 102, IoT device, . . . ) and another communication device (e.g., another of the communication device 110, device 108, VA 102, IoT device, . . . ) associated with the communication network 112 in the communication network environment. The communication network 112 and/or the core network also can allocate resources to the communication devices in the communication network 112, convert or enforce protocols, establish and enforce quality of service (QoS) for the communication devices, provide applications or services in the communication network 112, translate signals, and/or perform other desired functions to facilitate system interoperability and communication in the communication network 112 (e.g., wireless portion of the communication network 112 or wireline portion of the communication network 112). The communication network 112 and/or the core network further can comprise desired components, such as routers, nodes (e.g., general packet radio service (GPRS) nodes, such as serving GPRS support node (SGSN), gateway GPRS support node (GGSN)), switches, interfaces, controllers, etc., that can facilitate communication of data between communication devices in the communication network environment.

As a communication device(s) (e.g., communication device 110, device 108, VA 102, IoT device, . . . ) is moved through a wireless communication network environment, at various times, the communication device(s) can be connected (e.g., wirelessly connected) to one of a plurality of base stations or APs (e.g., macro or cellular AP, femto AP, pico AP, wi-fi AP, wi-max AP, hotspot (e.g., hotspot 1.x, hotspot 2.x, where x is an integer number; communication device (e.g., communication device functioning as a mobile hotspot)) that can operate in the wireless communication network environment. An AP (e.g., base station) can serve a specified coverage area to facilitate communication by the communication device(s) or other communication devices in the wireless communication network environment. An AP can serve a respective coverage cell (e.g., macrocell, femtocell, picocell, . . . ) that can cover a respective specified area, and the AP can service mobile wireless devices, such as the communication device(s) located in the respective area covered by the respective cell, where such coverage can be achieved via a wireless link (e.g., uplink (UL), downlink (DL)). When an attachment attempt is successful, the communication device(s) can be served by the AP and incoming voice and data traffic can be paged and routed to the communication device(s) through the AP, and outgoing voice and data traffic from the communication device(s) can be paged and routed through the AP to other communication devices in the communication network environment. In an aspect, the communication device(s) can be connected and can communicate wirelessly using virtually any desired wireless technology, including, for example, cellular, Wi-Fi, Gi-Fi, Hi-Fi, Wi-Max, Bluetooth, wireless local area networks (WLAN), etc.

The disclosed subject matter, by employing the VAMC 114, and the VA(s) (e.g., VA 102), can enable desirable managing of interactions, including managing a VA(s) during the interaction and managing the participation of participants (or potential participants) in the interaction, wherein the VAMC 114 can take into consideration advanced VA states, including context associated with the interaction and/or user 104, sentiment and personality attributes of the user 104, and/or environmental conditions associated with the user 104, in managing the interactions, as more fully described herein. The disclosed subject matter (e.g., employing the VAMC 114) can allow tracking and understanding of user states, VA states, privileges of VAs (e.g., as granted by users), context, sentiment and personality attributes of a user, and/or environmental conditions associated with an interaction, and making determinations and managing a VA(s) (and/or other participants) associated with an interaction based at least in part on the tracking and understanding of user states, VA states, VA privileges, context, sentiment and personality attributes of a user, and/or environmental conditions associated with a user or interaction.

The disclosed subject matter, by employing the VAMC 114 and VA 102, can provide for increased engagement with VAs by users via adaptable and personalized engagement of VAs with users, as more fully described herein. As a service (e.g., VA-related service) that can adapt to each user and can be accessible by other VA devices (e.g., the learned or determined personality attributes of a user and/or determined VA personality attributes of a VA that can be used by a VA during an interaction with the user can be used by or across different VAs during interactions with the user), the disclosed subject matter, by employing the VAMC 114 and VA 102, can be a long-term overlay path for desirably consistent VA/companion usage.

The disclosed subject matter, by employing the VAMC 114 and VA 102, can provide improved user (e.g., customer) service and experience through personalization of personality attributes, such as, for example, sympathy, humor, politeness, etc., of a user.

The disclosed subject matter, by employing the VAMC 114 and VA 102, can provide for enhanced personalization during interactions between VAs and users, and learning of preferences of users, and can provide more natural and intelligent techniques and methods for gathering and/or determining user (e.g., customer) preferences. Also, the disclosed subject matter, by employing the VAMC 114 and VA 102, and the techniques described herein, can enable a VA to ask a user casual questions in context and in accordance with the sentiment and personality attributes of the user (e.g., after the VA relating to family by presenting (e.g., telling) a joke regarding family to the user, the VA can ask the user about the family preferences of the user), instead of abruptly asking the user blatant form-filling questions to obtain answers to fill in a form.

The disclosed subject matter, by employing the VAMC 114 and VA 102, can provide for a standardized application programming interface (API), with regard to VAs, to enable for a personality overlay (e.g., overlay the personality of the user and/or the VA personality of the VA that can correspond to or complement the personality of the user) and sentiment inference of the sentiment of the user from various inputs, including multimedia inputs. The VAMC 114 can expose the personality attributes overlay layer to enable the personality attributes overlay layer to be readily utilized, via an API (e.g., standard API), on different VA and IoT interactive devices (e.g., device 108, communication device 110, and/or device(s) 206). The disclosed techniques employed by the VAMC 114 can provide a service for learning and adapting the personality attributes of the user, VA personality attributes of a VA, and/or the dialog state of a dialog (e.g., between a VA and user 104), wherein the client and/or VAMC 114 can readily perform or implement such learning and adapting by querying current weights (e.g., weights for personality attributes, weights for responses or actions of the VA, . . . ) and recommended (e.g., suggested) actions (e.g., actions for VA to take or perform).

The disclosed subject matter, by employing the VAMC 114 and VA 102, can provide for enhanced customer retention, and fulfillment of a societal duty, for example, by allowing users to vent or air grievances before leaving irritating engagements (e.g., interactions) or otherwise allowing users to express what is on their mind during engagements.

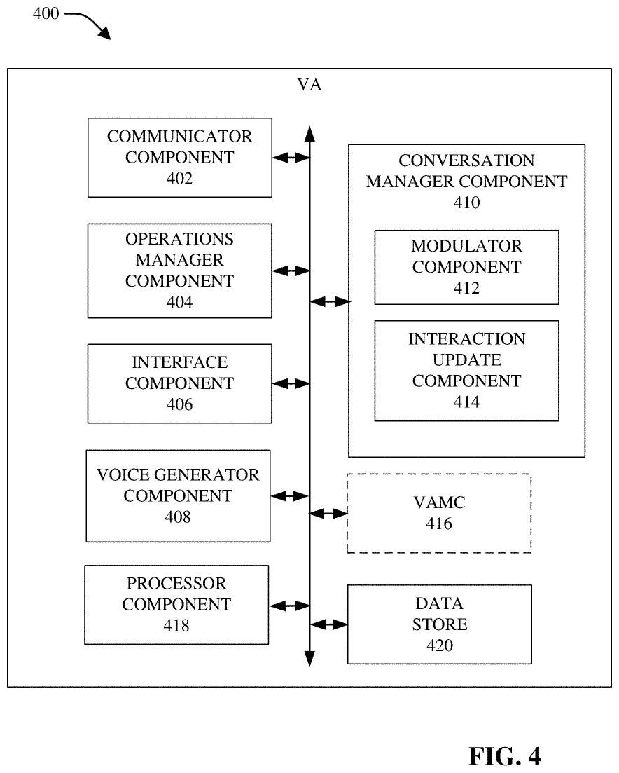

FIG. 4 depicts a block diagram of an example VA 400, in accordance with various aspects and embodiments of the disclosed subject matter. The VA 400 can comprise, for example, a communicator component 402, an operations manager component 404, an interface component 406, a voice generator component 408, a conversation manager component 410, a modulator component 412, and an interaction update component 414. In some embodiments, the VA 400 also can include (e.g., optionally can include) a VAMC 416.

The communicator component 402 can transmit information from the VA 400 to a user(s), or another component(s) or device(s) (e.g., another VA, a communication device, a network component or device, . . . ) and/or can receive information from the user, other component(s), or device(s). For instance, the communicator component 402 can receive (e.g., from the user, another VA, or a communication device of the user) information relating to an event, and/or other interaction-related information, in connection with an interaction between the VA and the user, other component, or device, identifier or authentication information (e.g., user ID, device ID, biometric information, communication network address, . . . ) associated with, and/or identifying or facilitating authenticating, the user, an entity, component, or device, and/or other desired information. The communicator component 402 also can transmit, to the user, the other component, or the other device, for example, information relating to an event, and/or other interaction-related information, in connection with an interaction between the VA and the user, identifier or authentication information associated with, and/or identifying or facilitating authenticating, the VA 400 or an entity associated with the VA 400, and/or other desired information.

The operations manager component 404 can control (e.g., manage) operations associated with the VA 400. For example, the operations manager component 404 can facilitate generating instructions to have components of the VA 400 perform operations, and can communicate respective instructions to respective components (e.g., communicator component 402, interface component 406, voice generator component 408, conversation manager component 410, modulator component 412, interaction update component 414, VAMC 416, . . . ) of the VA 400 to facilitate performance of operations by the respective components of the VA 400 based at least in part on the instructions, in accordance with the defined VA management criteria and a VA management algorithm(s) (e.g., VA management algorithms as disclosed, defined, recited, or indicated herein by the methods, systems, and techniques described herein). The operations manager component 404 also can facilitate controlling data flow between the respective components of the VA 400 and controlling data flow between the VA 400 and another component(s) or device(s) (e.g., another VA, a communication device, a base station or other network node component or device of the communication network) associated with (e.g., connected to) the VA 400.

The interface component 406 can comprise one or more interfaces, such as, for example, a display screen (e.g., touch display screen), an audio interface (e.g., microphone(s), speaker(s)), keyboard, keypad, controls, buttons, etc., that can be used to present information to a user associated with the VA 400 or receive information from the user, such as information that is input to the VA 400 by the user and is related to an event or is otherwise related to the interaction. The VA 400 can interact with and have a conversation with the user by using the speaker(s) of the interface component 406 to present verbal words to the user, and the VA 400 can receive, via a microphone(s) of the interface component 406, verbal words spoken by the user. As another example, the user can view information (e.g., information relating to the interaction or event) displayed on the display screen of the interface component 406.

The voice generator component 408 can generate one or more voices of the VA 400 for use in communicating (e.g., speaking) verbal words and sounds that can be emitted from the VA 400 via the interface component 406 and/or communicator component 402. A voice generated by the voice generator component 408 can be a virtual or emulated voice that can emulate, mimic, recreate, or sound similar to the actual voice of a human being. The voice can have various characteristics (e.g., word speed, speech cadence, inflection, tone, language, dialect, vocabulary level, . . . ) that can define or structure the voice and the speaking (e.g., virtual or emulated speaking) of verbal words by the voice generator component 408.

The conversation manager component 410 can manage (e.g., control, modify, or adjust) the voice (e.g., the characteristics of the virtual or emulated voice) and the emission (e.g., speaking) of verbal words by the voice generator component 408 to facilitate managing a conversation with a user (or another VA) based at least in part on the sentiment and personality attributes of the user, the context of the user or context of the interaction with the user (or other VA), including the verbal words spoken, and the characteristics of the verbal words spoken, by the user (or other VA) during the conversation, the environmental conditions associated with the user, and/or the VA personality attributes of the VA. The conversation manager component 410 also can determine and manage the verbal words to be emitted by the voice generator component 408 during the conversation, based at least in part on the sentiment and personality attributes of the user, the context of the user or the interaction, including what was said to the VA 400 by the user (or other VA) participating in the conversation, the environmental conditions associated with the user, and/or the VA personality attributes of the VA. For example, based at least in part on the sentiment and personality attributes of the user, the context, the environmental conditions, and/or the VA personality attributes, the conversation manager component 410 (e.g., in coordination with, or as managed by, the VAMC) can determine a question to ask or a statement to make to the user or other VA next in a conversation, a response to a question or statement made by the user or other VA to the VA 400, etc. The conversation manager component 410 can coordinate with, be managed by, and/or operate in conjunction with the VAMC to facilitate managing the voice, the determination of verbal words to be emitted, the emission of verbal words, and the overall conversing by the voice generator component 408, based at least in part on the sentiment and personality attributes of the user, the context, the environmental conditions, and/or the VA personality attributes, in accordance with the defined VA management criteria.

The conversation manager component 410 can comprise a modulator component 412 that can be utilized to modulate or adjust the voice, including adjusting the characteristics of the voice, produced by the voice generator component 408. For example, based at least in part on the sentiment and personality attributes of the user, the context, the environmental conditions, and/or the VA personality attributes, the modulator component 412 can adjust (e.g., increase or decrease) the speed and/or cadence of the verbal words emitted by the voice generator component 408, the inflection and/or tone of the voice and/or verbal words emitted by the voice generator component 408, the language and/or dialect of the verbal words emitted by the voice generator component 408, the vocabulary level of the verbal words emitted by the voice generator component 408, the syntax of the conversation, and/or one or more other characteristics of the voice or verbal words to facilitate producing verbal words that can enhance the flow of the conversation and enhance the productivity and results of the conversation and interaction with the user.

The interaction update component 414 can be employed to provide a catch-up service to enable a user (or VA) to be caught up or updated regarding the status or progress of an interaction when the user (or VA) is entering or re-entering a conversation associated with the interaction or when an update regarding the status or progress of the interaction is otherwise desired by the user. In some embodiments, the interaction update component 414 can coordinate with and/or can be managed by the VAMC to facilitate determining whether an update is to be provided to a user (or VA) and/or the content of the update to be provided to the user (or VA). The interaction update component 414 can determine and/or generate, or facilitate determining and/or generating, an update, comprising interaction update information relating to the interaction, based at least in part on the current context of the interaction, including the current status or progress of the interaction. The interaction update information can comprise a summary or a subset of interaction-related information and/or event-related information, for example. The VA 400 can present the interaction update (e.g., interaction update information) to the user (or VA, such as another VA) via the interface component 406 or the communicator component 402.

In some embodiments, the VA 400 can comprise (e.g., optionally can comprise) the VAMC 416 that can control the VA 400 during an interaction between the VA 400 and a user, another VA, or another device or component, as more fully described herein. In other embodiments, the VAMC can be separate from, but associated with (e.g., communicatively connected to), the VA 400 to control the VA 400 during an interaction between the VA 400 and a user, another VA, or another device or component, as more fully described herein.

The VA 400 also can include a processor component 418 that can work in conjunction with the other components (e.g., communicator component 402, interface component 406, voice generator component 408, conversation manager component 410, modulator component 412, interaction update component 414, VAMC 416, and data store 420) to facilitate performing the various functions of the VA 400. The processor component 418 can employ one or more processors, microprocessors, or controllers that can process data, such as information relating to interactions, events, contexts of users or interactions, status or progress of interactions, sentiments of users, personality attributes of users, VA personality attributes of the VA 400, activities relating to interactions, environmental conditions associated with users or interactions, conversations associated with the VA 400, identifiers or authentication credentials associated with entities, devices, or components, voice generation of the VA 400, characteristics or modulations of the one or more voices generated by the VA 400, catch-up service, parameters, traffic flows, policies, defined VA management criteria, algorithms (e.g., VA management algorithm(s)), protocols, interfaces, tools, and/or other information, to facilitate operation of the VA 400, as more fully disclosed herein, and control data flow between the VA 400 and other components (e.g., other VAs, communication devices, base stations, network devices of the communication network, data sources, applications, . . . ) associated with the VA 400.

The data store 420 can store data structures (e.g., user data, metadata), code structure(s) (e.g., modules, objects, hashes, classes, procedures) or instructions, information relating to interactions, events, contexts of users or interactions, status or progress of interactions, sentiments of users, personality attributes of users, VA personality attributes of the VA 400, activities relating to interactions, environmental conditions associated with users or interactions, conversations associated with the VA 400, identifiers or authentication credentials associated with entities, devices, or components, voice generation of the VA 400, characteristics or modulations of the one or more voices generated by the VA 400, catch-up service, parameters, traffic flows, policies, defined communication management criteria, algorithms (e.g., VA management algorithm(s)), protocols, interfaces, tools, and/or other information, to facilitate controlling operations associated with the VA 400. In an aspect, the processor component 418 can be functionally coupled (e.g., through a memory bus) to the data store 420 in order to store and retrieve information desired to operate and/or confer functionality, at least in part, to the communicator component 402, interface component 406, voice generator component 408, conversation manager component 410, modulator component 412, interaction update component 414, VAMC 416, and data store 420, etc., and/or substantially any other operational aspects of the VA 400.

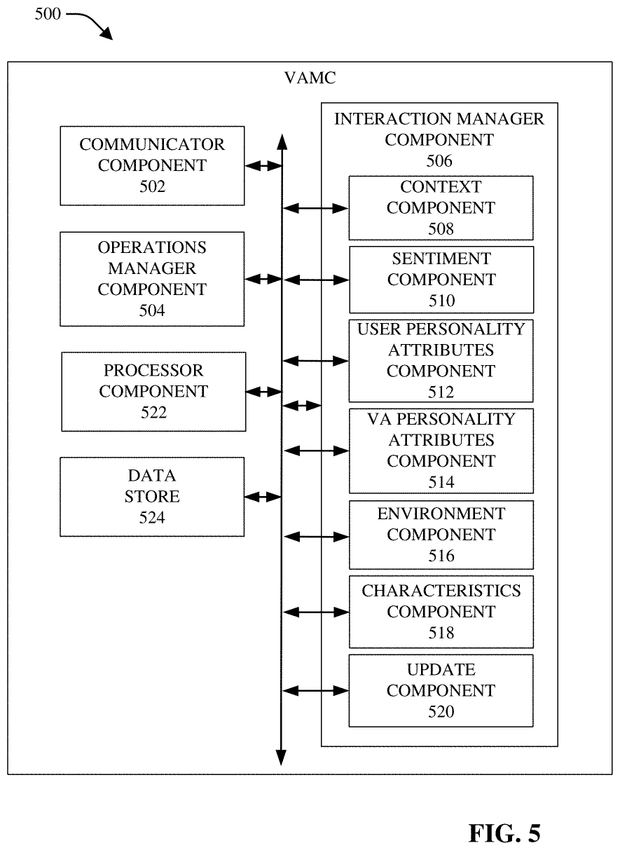

FIG. 5 illustrates a block diagram of an example VA management component (VAMC) 500, in accordance with various aspects and embodiments of the disclosed subject matter. The VAMC 500 can comprise, for example, a communicator component 502, an operations manager component 504, and an interaction manager component 506, wherein the interaction manager component 506 can comprise a context component 508, a sentiment component 510, a user personality attributes component 512, a VA personality attributes component 514, an environment component 516, a characteristics component 518, and an update component 520. The VAMC 500 also can include a processor component 522, and a data store 524. The VAMC 500 can be the same as or similar to that, and/or can comprise the same or similar functionality, as more fully described herein.

The communicator component 502 can transmit information from the VAMC 500 to another component(s) or device(s) (e.g., a VA, a communication device, a network component or device, . . . ) and/or can receive information from the other component(s) or device(s). For instance, the communicator component 502 can receive (e.g., from a VA, or a communication device associated with a user) information relating to an interaction (e.g., interaction-related information, event-related information), identifier or authentication information (e.g., device ID, user ID, authentication credentials, biometric information, and/or communication network address, . . . ) associated with an entity, component, or device, and/or other desired information. The communicator component 502 also can, for example, transmit, to a VA or user (e.g., communication device of a user), information relating to the interaction, modification information (e.g., to modify the characteristics of the voice or verbal words presented by a VA; to modify the conversation by modifying the statements made by the VA), participant-related information to change participants actively engaging in the interaction, update information relating to the interaction, and/or other information.

The operations manager component 504 that can control (e.g., manage) operations associated with the VAMC 500. For example, the operations manager component 504 can facilitate generating instructions to have components of the VAMC 500 perform operations, and can communicate respective instructions to respective components (e.g., communicator component 502, operations manager component 504, interaction manager component 506, . . . ) of the VAMC 500 to facilitate performance of operations by the respective components of the VAMC 500 based at least in part on the instructions, in accordance with the defined VA management criteria and a VA management algorithm(s) (e.g., VA management algorithms as disclosed, defined, recited, or indicated herein by the methods, systems, and techniques described herein). The operations manager component 504 also can facilitate controlling data flow between the respective components of the VAMC 500 and controlling data flow between the VAMC 500 and another component(s) or device(s) (e.g., a VA, a communication device, a base station or other network node component or device of the communication network) associated with (e.g., connected to) the VAMC 500.

The interaction manager component 506 can manage interactions, including managing conversations between participants (e.g., user, VA, another VA, or another device or component) in interactions, verbal words or other information presented by a VA to a user (or other VA) during an interaction, interaction updates regarding interactions to users or VAs entering an interaction or otherwise desired by users or VAs, and/or other aspects relating to interactions, based at least in part on the context of a user or interaction (e.g., the context of an interaction at a given time), a sentiment of a user during the interaction, personality attributes of the user, VA personality attributes of the VA, and/or environmental conditions of an environment associated with the user, in accordance with the defined VA management criteria. In some embodiments, based at least in part on the context, user sentiment, user personality attributes, VA personality attributes, and/or environmental conditions, the interaction manager component 506 can determine the words to be presented by a VA (e.g., how the VA is to respond to a user) during the interaction, the characteristics of the voice or the verbal words presented by the VA during the interaction, and/or other information (e.g., video or audio content, visual images, textual information, . . . ) to be presented by the VA (e.g., to the user).

The interaction manager component 506 can employ the context component 508 to determine the context of a user and/or an interaction at a given time during an interaction. The context component 508 can determine the context of the user and/or interaction overall based at least in part on current or recent information regarding the user and/or interaction, historical information that can be relevant to the user and/or interaction, and/or other information that can be relevant to the user and/or interaction. The historical information can relate to the user, the type of interaction (e.g., type of event associated with the interaction, an item (e.g., item for sale) associated with the interaction, the participants (e.g., the user(s), the VA or type of VA, . . . ) in the interaction), a relationship (e.g., a previous relationship or interaction(s) between participants in the interaction), the location of the interaction or part of the interaction, etc. If the context component 508 determines that the context has changed during the interaction (e.g., based on new information), the context component 508 can update the context to facilitate controlling operation of the VA during the interaction, based at least in part on the updated context.

The sentiment component 510 can determine a sentiment (e.g., attitude, feeling, or mood, . . . ) of the user during an interaction based at least in part on the results of analyzing current or recent information presented (e.g., words spoken and/or information otherwise presented) by the user to the VA, current or recent reaction(s) of the user during the interaction with the VA, and/or other information determined to be relevant to determining the sentiment of the user during the interaction. If the sentiment component 510 determines that the sentiment of the user has changed during the interaction (e.g., based on new information), the sentiment component 510 can update the sentiment to facilitate controlling operation of the VA during the interaction, based at least in part on the updated sentiment of the user.

The user personality attributes component 512 can determine personality attributes of the user based at least in part on the results of analyzing current or historical information presented (e.g., words spoken and/or information otherwise presented) by the user to the VA during the current or previous interactions associated with the user, current or historical reaction(s) of the user during the current or previous interactions associated with the user, and/or other information determined to be relevant to determining the personality attributes of the user. If (e.g., based on new information during the interaction) the user personality attributes component 512 determines or learns a personality attribute of the user during the interaction, or determines that a personality attribute of the user has changed during the interaction, the user personality attributes component 512 can update the personality attributes of the user to facilitate controlling operation of the VA during the interaction, based at least in part on the updated personality attributes of the user.

The VA personality attributes component 514 can determine VA personality attributes of a VA to use with respect to an interaction between the VA and a user based at least in part on the sentiment of the user during the interaction, the context of the user or interaction, personality attributes of the user, and/or other information determined to be relevant to determining the VA personality attributes. If (e.g., based on new information during the interaction) the VA personality attributes component 514 determines or learns a VA personality attribute of the VA during the interaction, or determines that a VA personality attribute of the VA is to be changed during the interaction, the VA personality attributes component 514 can update the VA personality attributes of the VA to facilitate controlling operation of the VA during the interaction, based at least in part on the updated VA personality attributes of the VA with respect to the user.

The environment component 516 can determine environmental conditions associated with the user during an interaction based at least in part on the results of analyzing environment-related information (e.g., visual or video images, audio information, sensor data, . . . ) obtained from one or more devices (e.g., IoT device, thermostat, . . . ) or sensors (e.g., temperature or weather sensors, sensors in a vehicle, sensors in a house or building, . . . ) associated with the environment where the user is located. The environmental conditions can relate to, for example, weather conditions, allergen conditions, ambient conditions (e.g., in the home, building, or vehicle), structural conditions of a structure (e.g., home, building, vehicle), sounds or noises (e.g., background sounds or noises) in the environment, and/or objects (e.g., television, appliances, furniture, persons, vehicles, roads, structures, . . . ) located in the environment, etc. If (e.g., based on new information during the interaction) the environment component 516 determines or learns that environmental conditions have changed during the interaction, the environment component 516 can update the environment-related information to reflect the changes to the environmental conditions to facilitate controlling operation of the VA during the interaction, based at least in part on the updated environmental conditions.

The characteristics component 518 can determine the characteristics of the voice and verbal words being presented by a VA at a given time and/or modifications that can be made to the characteristics of the voice and verbal words being presented by a VA at a given time, based at least in part on the context, user sentiment, user personality attributes, VA personality attributes, and/or environmental conditions, to facilitate enhancing the presentation of verbal words by the VA to the user (or another VA or entity), the conversation between the VA and the user (or another VA or entity), and the productivity and results of the interaction. For example, during an interaction, based at least in part on the context, user sentiment, user personality attributes, VA personality attributes, and/or environmental conditions determined with respect to the interaction, the characteristics component 518 can determine that a speed, cadence, and/or inflection of the presentation of words by a VA to the user is to be modified (e.g., speed is to be decreased, cadence is to be adjusted, and/or inflection is to be adjusted) to facilitate enhancing the conversation between the VA and the user, wherein the context, sentiment, and/or personality attributes of the user can indicate that the user has not been responding sufficiently well or in a positive manner to the verbal words being presented by the VA to the user.

The update component 520 can determine an update that can be performed on the user profile of a user, based at least in part on information relating to the interaction, including dialog between a VA and a user (or other VA or device) during the interaction, results of the interaction, information relating to context, sentiment, and personality attributes of the user during the interaction (e.g., sentiment or personality attributes of the user learned or determined during the interaction), information relating to environmental conditions associated with the user, and/or information relating VA personality attributes of the VA, etc. The update component 520 can update the user profile of the user based at least in part on the update determined with respect to the user.

In some embodiments, the update component 520 also can be employed to provide a catch-up service to enable a user (or VA) to be caught up or updated regarding the status or progress of an interaction when the user (or VA) is entering or re-entering a conversation associated with the interaction or when an update regarding the status or progress of the interaction is otherwise desired by the user. In some embodiments, the update component 520 can coordinate with a VA to facilitate determining whether an interaction update is to be provided to a user (or VA) and/or the content of the interaction update to be provided to the user (or VA). The update component 520 can determine and/or generate, or facilitate determining and/or generating, an interaction update, comprising interaction update information relating to the interaction, based at least in part on the current context of the user or interaction, including the current status or progress of the interaction, current sentiment of the user, and/or other desired information associated with the interaction. The interaction update information can comprise, for example, a summary or a subset of interaction-related information and/or event-related information. The interaction manager component 506, employing the communicator component 502, can present the interaction update (e.g., interaction update information) to the user (or VA) via the communicator component 502.

The processor component 522 that can work in conjunction with the other components (e.g., communicator component 502, operations manager component 504, interaction manager component 506, . . . , and data store 524) to facilitate performing the various functions of the VAMC 500. The processor component 522 can employ one or more processors, microprocessors, or controllers that can process data, such as information relating to interactions, events, contexts of users or interactions, status or progress of interactions, sentiments of users, personality attributes of users, VA personality attributes of a VA, activities relating to interactions, environmental conditions associated with users or interactions, conversations associated with participants of interactions, identifiers or authentication credentials associated with entities, devices, or components, voice generation of a VA, characteristics or modulations of one or more voices generated by a VA, updates to user profiles of users, catch-up (e.g., interaction update) service, parameters, traffic flows, policies, defined VA management criteria, algorithms (e.g., VA management algorithm(s)), protocols, interfaces, tools, and/or other information, to facilitate operation of the VAMC 500, as more fully disclosed herein, and control data flow between the VAMC 500 and other components (e.g., VAs, communication devices, base stations, network devices of the communication network, data sources, applications, . . . ) associated with the VAMC 500.

The data store 524 that can store data structures (e.g., user data, metadata), code structure(s) (e.g., modules, objects, hashes, classes, procedures) or instructions, information relating to interactions, events, contexts of users or interactions, status or progress of interactions, sentiments of users, personality attributes of users, VA personality attributes of a VA, activities relating to interactions, environmental conditions associated with users or interactions, conversations associated with participants of interactions, identifiers or authentication credentials associated with entities, devices, or components, voice generation of a VA, characteristics or modulations of one or more voices generated by a VA, updates to user profiles of users, catch-up (e.g., interaction update) service, parameters, traffic flows, policies, defined VA management criteria, algorithms (e.g., VA management algorithm(s)), protocols, interfaces, tools, and/or other information, to facilitate controlling operations associated with the VAMC 500. In an aspect, the processor component 522 can be functionally coupled (e.g., through a memory bus) to the data store 524 in order to store and retrieve information desired to operate and/or confer functionality, at least in part, to the communicator component 502, operations manager component 504, interaction manager component 506, and data store 524, etc., and/or substantially any other operational aspects of the VAMC 500.

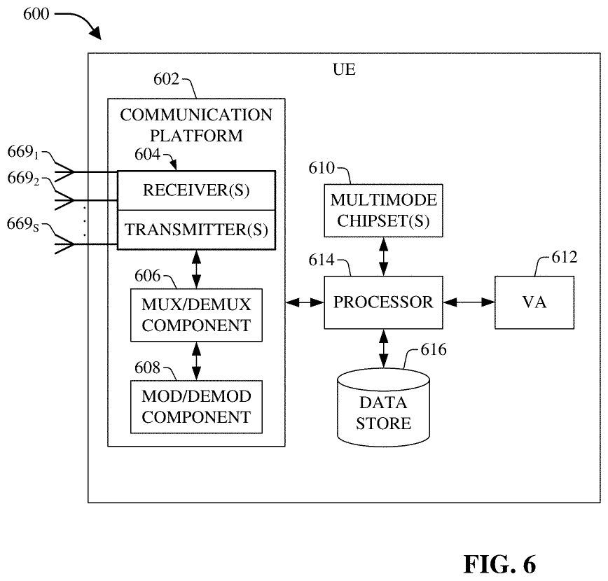

FIG. 6 depicts a block diagram of an example UE 600 (e.g., communication device) in accordance with various aspects and embodiments of the disclosed subject matter. In accordance with various embodiments, the UE 600 (e.g., communication device) can be a multimode access terminal, wherein a set of antennas 669₁-669_{S} (wherein S can be a positive integer) can receive and transmit signal(s) from and to wireless devices like access points, access terminals, wireless ports and routers, and so forth, that operate in a radio access network. It should be appreciated that antennas 669₁-669_{S} can be a part of communication platform 602, which comprises electronic components and associated circuitry that provide for processing and manipulation of received signal(s) and signal(s) to be transmitted; e.g., receivers and transmitters 604, multiplexer/demultiplexer (mux/demux) component 606, and modulation/demodulation (mod/demod) component 608.

In some implementations, the UE 600 can include a multimode operation chipset(s) 610 that can allow the UE 600 to operate in multiple communication modes in accordance with disparate technical specification for wireless technologies. In an aspect, multimode operation chipset(s) 610 can utilize communication platform 602 in accordance with a specific mode of operation (e.g., voice, global positioning system (GPS), . . . ). In another aspect, multimode operation chipset(s) 610 can be scheduled to operate concurrently (e.g., when S>1) in various modes or within a multitask paradigm.

In certain embodiments, the UE 600 also can comprise (e.g., optionally can comprise or implement) a VA 612 that can interact with a user, perform services for, and/or perform functions or tasks for or on behalf of, the user, as more fully described herein. The VA 612 can comprise the same or similar functionality as more fully described herein with regard to other systems or methods disclosed herein.

The UE 600 also can include a processor(s) 614 that can be configured to confer functionality, at least in part, to substantially any electronic component within the UE 600, in accordance with aspects of the disclosed subject matter. For example, the processor(s) 614 can facilitate enabling the UE 600 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 614 can facilitate enabling the UE 600 to process data relating to messaging, voice calls, or other services (e.g., Internet services or access); information relating to measurements of signal conditions with respect to cells; information relating to cells to facilitate connection to a source cell or target cell; information relating to parameters (e.g., UE parameters, network-related parameters); information relating to interactions between the UE 600 and other devices or components (e.g., VA, another communication device), as more fully described herein; and/or other data. In certain embodiments, the processor(s) 614 can process data to facilitate implementing the VA 612 and/or facilitate enabling the VA 612 to interact with a user, perform services for, and/or perform functions or tasks for or on behalf of, the user, as more fully described herein.

The UE 600 also can contain a data store 616 that can store data structures (e.g., user data, metadata); code structure(s) (e.g., modules, objects, classes, procedures) or instructions; message hashes; neighbor cell list; one or more lists (e.g., whitelist, etc.); information relating to measurements of signal conditions with respect to cells; information relating to cells to facilitate connection to a source cell or target cell; information relating to parameters (e.g., UE parameters, network-related parameters); information relating to interactions between the UE 600 and other devices or components (e.g., VA, another communication device); UE identifier; information relating to voice calls, messaging, or other services associated with the UE 600; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In certain embodiments, the data store 616 can store data relating to the VA 612 to facilitate implementing the VA 612 and/or facilitate enabling the VA 612 to interact with a user, perform services for, and/or perform functions or tasks for or on behalf of, the user, as more fully described herein. In an aspect, the processor(s) 614 can be functionally coupled (e.g., through a memory bus) to the data store 616 in order to store and retrieve information (e.g., neighbor cell list; signal quality measurement-related information; cell-related information; parameter information; information relating to messaging, voice calls, or other services (e.g., interactive services); information relating to interactions; frequency offsets; desired algorithms; security code; UE identifier; . . . ); and/or VA-related data that can be desired to operate and/or confer functionality, at least in part, to communication platform 602, multimode operation chipset(s) 610, the VA 612, and/or substantially any other operational aspects of the UE 600.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

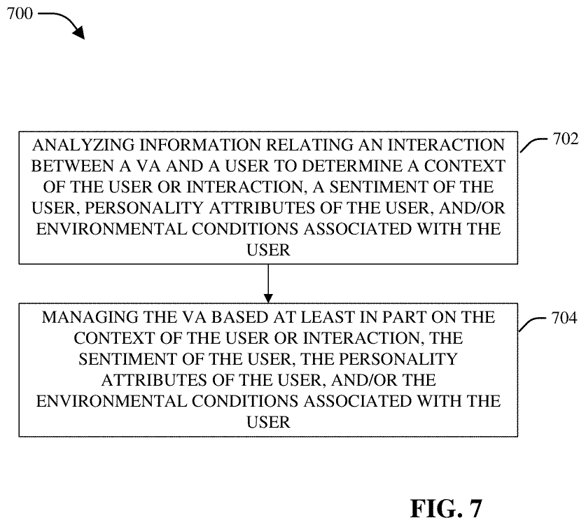

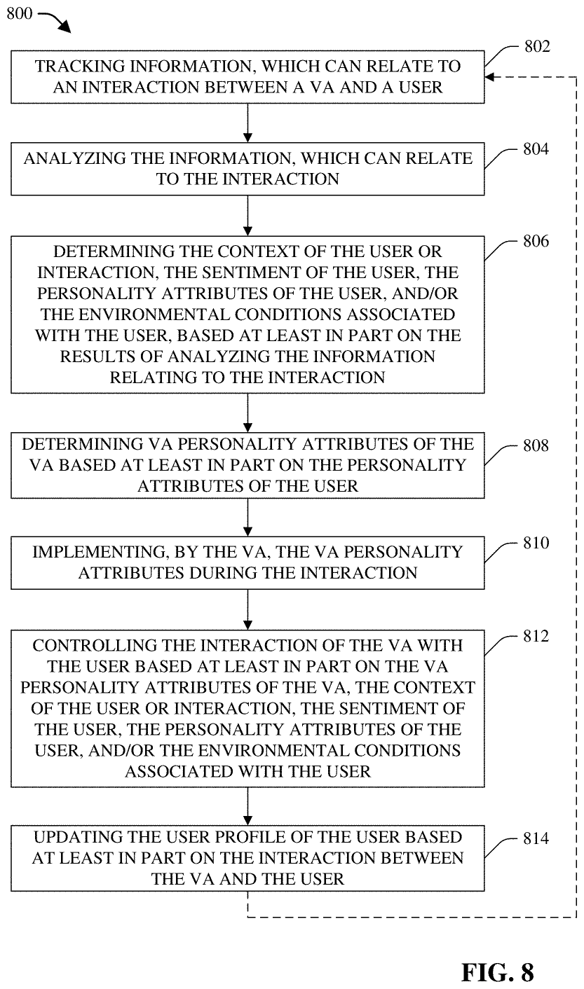

In view of the example systems and/or devices described herein, example methods that can be implemented in accordance with the disclosed subject matter can be further appreciated with reference to flowcharts in FIGS. 7-8. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can manage a VA in interactions with a user, in accordance with various aspects and embodiments of the disclosed subject matter. The method 700 can be employed by, for example, a system comprising the VAMC, a processor component (e.g., of or associated with the VAMC), and/or a data store (e.g., of or associated with the VAMC).

At 702, information relating an interaction between a VA and a user can be analyzed to determine a context of the user or interaction, a sentiment of the user, personality attributes of the user, and/or environmental conditions associated with the user. The VAMC can track and/or receive information relating to the interaction between the VA (e.g., VA device) and the user and/or communication device associated with the user. The interaction can be, for example, a conversation between the VA and the user who can be communicating directly with the VA or using the communication device to communicate with the VA. The information relating to the interaction can comprise, for example, data (e.g., event data relating to an event, sensor data (obtained from sensors) relating to the event and/or environmental conditions, . . . ) being exchanged between the VA and the user or otherwise related to the interaction, a speed of the respective conversing (e.g., communication of verbal or audible words) of the VA and the user, respective voice tones, inflections, or cadences of the VA and the user, other respective characteristics of the VA and user with respect to the interaction, the progress or status of the conversation between the VA and user (e.g., progress or status of filing an insurance claim, progress or status of a purchase of a product or service, or progress or status relating to another type of event).

Based at least in part on the results of analyzing the information relating to the interaction, the VAMC can determine the context of the user or interaction, the sentiment of the user, the personality attributes of the user, and/or the environmental conditions associated with the user. In some embodiments, as part of the analysis of the information, the VAMC can utilize facial recognition techniques or other recognition techniques to recognize or determine facial features and expressions of the user, and/or gestures or features of other parts (e.g., hands, arms, legs, . . . ) of the body of the user; voice or speech recognition and analysis techniques to recognize or determine characteristics (e.g., word speed, voice tone, voice cadence, voice inflection, language, dialect, vocabulary level, . . . ) of the voice or speech of the user (or another person (e.g., baby, child, or spouse)); and/or other desired recognition or analysis techniques.

At 704, the VA can be managed based at least in part on the context of the user or interaction, the sentiment of the user, the personality attributes of the user, and/or the environmental conditions associated with the user. The VAMC can manage the VA (e.g., control operation of the VA) with respect to the interaction between the VA and the user, based at least in part on the context of the user or interaction, the sentiment of the user, the personality attributes of the user, and/or the environmental conditions associated with the user, to facilitate enhancing the interaction, including the user experience, between the VA and the user and/or achieving a desired goal(s) for the user and/or other entity (e.g., business that utilizes the VA to sell products or services, medical provider that utilizes the VA in connection with providing medical services or assistance, or law enforcement entity that utilizes the VA in connection with providing law enforcement services or assistance). For instance, based at least in part on the context of the user or interaction, the sentiment of the user, the personality attributes of the user, and/or the environmental conditions associated with the user, the VAMC can manage (e.g., control, modify, adjust, or modulate) a speed of presentation of audible or verbal words by the VA to the user. In accordance with various embodiments, the VAMC also can manage a tone of voice (e.g., virtual or emulated voice) of the VA, an inflection of the voice of the VA, a cadence of the audible or verbal words being presented by the VA, and/or other characteristics of the voice of the VA, based at least in part on the context of the user or interaction, the sentiment of the user, the personality attributes of the user, and/or the environmental conditions associated with the user, as more fully described herein.

In certain embodiments, the VAMC can determine VA personality attributes for the VA that can correspond to, mirror, and/or complement the personality attributes of the user, based at least in part on one or more interactions between the VA (or another VA(s)) and the user. The VAMC can determine respective parameters of respective characteristics (e.g., word speed of verbal words, voice inflection, voice cadence, voice tone, vocabulary level, . . . ) of the voice (e.g., emulated or virtual voice) of the VA and/or other characteristics of other services (e.g., media presentation, information presentation, or purchase or sales related services, . . . ) or features of the VA, based at least in part on the VA personality attributes of the VA. The VAMC can manage the respective parameters of the respective characteristics of the voice of the VA and/or the other characteristics based at least in part on the VA personality attributes of the VA.

FIG. 8 presents a flow chart of another example method 800 that can manage a VA in interactions with a user, in accordance with various aspects and embodiments of the disclosed subject matter. The method 800 can be employed by, for example, a system comprising a system comprising the VAMC, a processor component (e.g., of or associated with the VAMC), and/or a data store (e.g., of or associated with the VAMC).

At 802, information, which can relate to an interaction between a VA and a user, can be tracked. The VAMC can monitor and track the interaction between the VA and the user. The VAMC can receive and/or generate information relating to the interaction based at least in part on the monitoring and tracking of the interaction, and/or can monitor and track the information relating to the interaction. The information can comprise or relate to, for example, verbal words spoken by the user, verbal words presented by the VA to the user, other types of information (e.g., visual, audio, and/or textual information, visual images, video content, or audio content, . . . ) presented by the VA to the user (or vice versa), information (e.g., sensor data) relating to environmental conditions associated with the environment where the user is located, information obtained by the VA or VAMC from another device(s) (e.g., IoT device, television, computer, electronic tablet, electronic eyeglasses or bodywear, or mobile or smart phone, . . . ).

At 804, the information, which can relate to the interaction, can be analyzed. The VAMC can analyze the information to facilitate determining a context of the user or interaction, a sentiment of the user, personality attributes of the user, and/or environmental conditions associated with the user. The VAMC can employ visual analysis techniques (e.g., facial recognition techniques, gesture recognition techniques, . . . ), audio analysis techniques (e.g., voice and/or speech analysis or recognition techniques), personality analysis techniques, biometric analysis techniques, and/or other desired analysis techniques to analyze the information relating to the interaction and identify characteristics (e.g., visual characteristics, audio characteristics, personality attributes, other characteristics or attributes) associated with respective items of information and/or the user.

At 806, the context of the user or interaction, the sentiment of the user, the personality attributes of the user, and/or the environmental conditions associated with the user can be determined, based at least in part on the results of analyzing the information relating to the interaction. The VAMC can determine the context of the user or interaction, the sentiment of the user, the personality attributes of the user, and/or the environmental conditions associated with the user, based at least in part on the results of analyzing the information relating to the interaction, as more fully described herein.

At 808, VA personality attributes of the VA can be determined based at least in part on the personality attributes of the user. The VAMC can determine the VA personality attributes of the VA based at least in part on the personality attributes of the user and/or sentiment of the user. In some embodiments, the VAMC can determine VA personality attributes of the VA that can correspond to, emulate, mirror, or complement the personality attributes determined for the user.

In some embodiments, a preliminary set of VA personality attributes can be determined based at least in part on identification of the user by the VA or VAMC, and a user profile (e.g., personality attributes stored in the user profile) associated with the user. In certain embodiments, if no personality attributes of the user are available or known by the VA or VAMC, the VAMC can determine or select a set of default VA personality attributes that can be used, at least initially, by the VA during the interaction with the user. As the VAMC learns or determines the more predominant personality attributes of the user during the interaction, the VAMC can accordingly determine adjustments to the VA personality attributes of the VA (e.g., current, preliminary, or default VA personality attributes) to implement during the remainder of the interaction.

At 810, the VA personality attributes can be implemented by the VA during the interaction. The VAMC can control the VA to have the VA implement the VA personality attributes during the interaction, or portion thereof (e.g., until and unless a modification to the VA personality attributes is made).

At 812, the interaction of the VA with the user can be controlled based at least in part on the VA personality attributes of the VA, the context of the user or interaction, the sentiment of the user, the personality attributes of the user, and/or the environmental conditions associated with the user. The VAMC can control the interaction of the VA with the user based at least in part on the VA personality attributes of the VA, the context of the user or interaction, the sentiment of the user, the personality attributes of the user, and/or the environmental conditions associated with the user. For instance, the characteristics of the voice (e.g., emulated or virtualized voice) of the VA, and/or other characteristics of other services (e.g., media presentation, information presentation, or purchase or sales related services, . . . ) or features of the VA, can be controlled based at least in part on the VA personality attributes of the VA, the context of the user or interaction, the sentiment of the user, the personality attributes of the user, and/or the environmental conditions associated with the user. For example, the characteristics of the voice of the VA can be controlled by the VAMC to have the voice correspond to or emulate the VA personality attributes of the VA, wherein the characteristics of the voice of the VA can be further controlled or refined by the VAMC based at least in part on the sentiment or context of the user, context of the interaction, and/or environmental conditions associated with the user.

At 814, the user profile of the user can be updated based at least in part on the interaction between the VA and the user. The VAMC can update the user profile of the user based at least in part on the interaction (e.g., information relating to and results of the interaction) between the VA and the user. For example, the VAMC can update the user profile of the user to include dialog between the VA and user during the interaction, sentiment(s) or context(s) of the user during the interaction, personality attributes of the user that were learned, determined, or refined (e.g., updated) during the interaction, VA personality attributes learned, determined, or refined (e.g., updated) during the interaction, engagement attribute preferences associated with the interaction, the results of the interaction, and/or other aspects or relevant information of or derived from the interaction, as more fully described herein.

In some embodiments, at this point, the method 800 can proceed from reference numeral 814 to reference numeral 802, wherein the method 800 can proceed to track information relating to the interaction between the VA and the user, and perform one or more operations of the method 800, as described herein. For instance, in accordance with the method 800, as the interaction continues to proceed, the VAMC can determine (e.g., at reference numeral 806) that the sentiment and/or context of the user is different than it was before, and, based at least in part on the different sentiment and/or context of the user, can determine that a VA personality attributes are to be modified or refined (e.g., at reference numeral 808), and/or can determine that modification of the characteristics of the voice of the VA and/or the other characteristics of the VA are to be modified to facilitate controlling the VA during the interaction, such as, for example, a later portion of the interaction (e.g., at reference numeral 812).

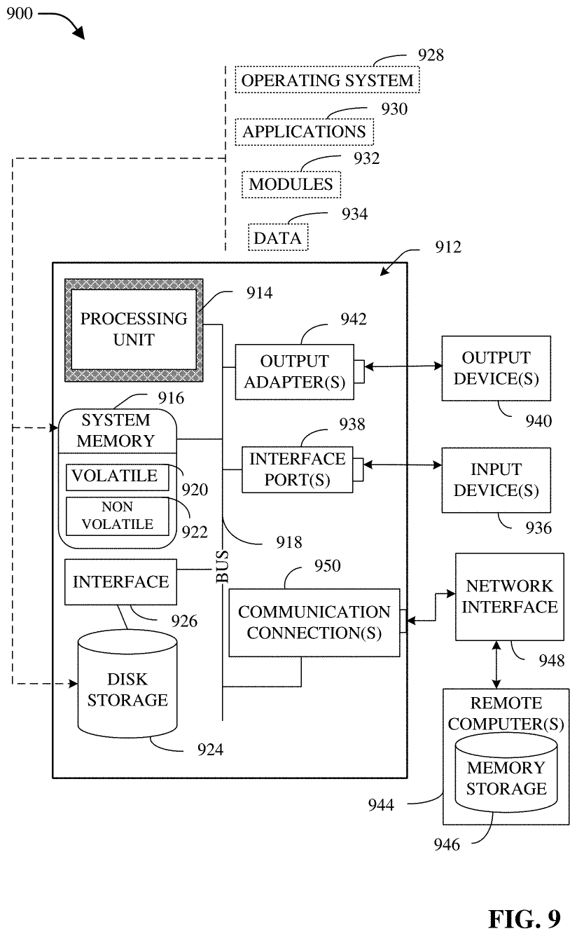

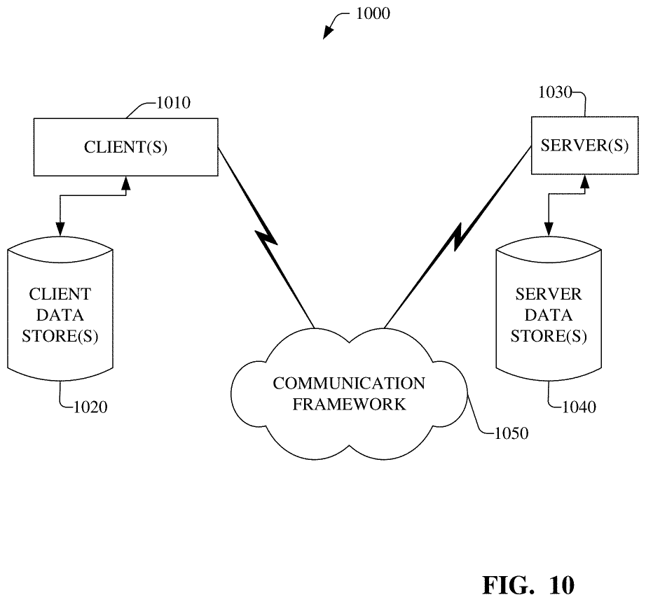

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., mobile phone, electronic tablets or pads, laptop computers, PDAs, . . . ), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

With reference to FIG. 9, a suitable environment 900 for implementing various aspects of this disclosure includes a computer 912. The computer 912 includes a processing unit 914, a system memory 916, and a system bus 918. It is to be appreciated that the computer 912 can be used in connection with implementing one or more of the systems, components, or methods shown and described in connection with FIGS. 1-8, or otherwise described herein. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM)). Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 also includes removable/non-removable, volatile/non-volatile computer storage media. FIG. 9 illustrates, for example, a disk storage 924. Disk storage 924 includes, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computer system 912. System applications 930 take advantage of the management of resources by operating system 928 through program modules 932 and program data 934 stored, e.g., in system memory 916 or on disk storage 924. It is to be appreciated that this disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 (e.g., computing system) with which the subject matter of this disclosure can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be noted that aspects, features, and/or advantages of the disclosed subject matter can be exploited in substantially any wireless telecommunication or radio technology, e.g., Wi-Fi; Gi-Fi; Hi-Fi; Bluetooth; worldwide interoperability for microwave access (WiMAX); enhanced general packet radio service (enhanced GPRS); third generation partnership project (3GPP) long term evolution (LTE); third generation partnership project 2 (3GPP2) ultra mobile broadband (UMB); 3GPP universal mobile telecommunication system (UMTS); high speed packet access (HSPA); high speed downlink packet access (HSDPA); high speed uplink packet access (HSUPA); GSM (global system for mobile communications) EDGE (enhanced data rates for GSM evolution) radio access network (GERAN); UMTS terrestrial radio access network (UTRAN); LTE advanced (LTE-A); etc. Additionally, some or all of the aspects described herein can be exploited in legacy telecommunication technologies, e.g., GSM. In addition, mobile as well non-mobile networks (e.g., the internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field PGA (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component”, “system”, “platform”, “framework”, “layer”, “interface”, “agent”, and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment” (UE), “mobile station,” “mobile,” “wireless device,” “wireless communication device,” “subscriber station,” “subscriber equipment,” “access terminal,” “terminal,” “handset,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point” (AP), “base station,” “node B,” “evolved node B” (eNode B or eNB), “home node B” (HNB), “home access point” (HAP), and the like are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “owner,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., communication device, virtual agent (VA), virtual agent management component (VAMC), communication network, processor component, data store, . . . ), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
analyzing, by a system comprising a processor, information relating to an interaction between a virtual agent device and a user to determine a context and a personality attribute associated with the user; and
controlling, by the system, a characteristic of the virtual agent device during the interaction with the user based on the context and the personality attribute associated with the user.

2. The method of claim 1, wherein the analyzing comprises analyzing the information relating to the interaction between the virtual agent device and the user to determine the context of the user, a sentiment of the user, the personality attribute associated with the user, and an environmental condition of an environment associated with the user; and
wherein the controlling comprises controlling the characteristic of the virtual agent device during the interaction with the user based on the context of the user, the sentiment of the user, the personality attribute associated with the user, and the environmental condition.

3. The method of claim 2, further comprising:
based on the context of the user, the sentiment of the user, the personality attribute associated with the user, and the environmental condition, modifying, by the system, at least one parameter of the characteristic of the virtual agent device to modify a presentation of audible words by the virtual agent device to the user.

4. The method of claim 1, further comprising:
determining, by the system, virtual-agent personality attributes of the virtual agent device based on personality attributes, comprising the personality attribute, associated with the user; and
mapping, by the system, the virtual-agent personality attributes to characteristics, comprising the characteristic, of the virtual agent device, wherein the controlling the characteristic comprises controlling the characteristics of the virtual agent device based on the mapping, the context of the user, and the personality attributes associated with the user.

5. The method of claim 4, wherein the virtual-agent personality attributes of the virtual agent device correspond to or complement the personality attributes associated with the user.

6. The method of claim 1, wherein the characteristic is selected from a group of characteristics comprising a speed of a presentation of audible words by the virtual agent device to the user, a tone of an emulated voice of the virtual agent device in connection with the presentation of the audible words, an inflection of the emulated voice of the virtual agent device in connection with the presentation of the audible words, and a cadence of the emulated voice of the virtual agent device in connection with the presentation of the audible words.

7. The method of claim 1, further comprising:
determining, by the system, interfaces of the virtual agent device or a device associated with the virtual agent device that are available to communicate with the user;
determining, by the system, an interaction communication to be presented to the user by the virtual agent device based on the determining of the interfaces that are available to communicate with the user, and based on the context of the user, a sentiment of the user, the personality attribute associated with the user, and an environmental condition of an environment associated with the user; and
controlling, by the system, the virtual agent device to have the virtual agent device communicate the interaction communication to the user via at least one interface of the interfaces.

8. The method of claim 7, wherein the interfaces comprise a first interface and a second interface, wherein the controlling the virtual agent device comprises controlling the virtual agent device to have the virtual agent device communicate a first portion of the interaction communication to the user via the first interface and communicate a second portion of the interaction communication to the user via the second interface, wherein the first portion comprises a visual image, wherein the first interface is a display screen, wherein the second portion comprises audible words presented by the virtual agent device, and wherein the second interface is an audio speaker.

9. The method of claim 1, wherein the virtual agent device is a first virtual agent device, and wherein the method further comprises:
determining, by the system, that the first virtual agent device is to present a first interaction communication to the user via an interface associated with a device and a second virtual agent device is to present a second interaction communication to the user via the interface; and
applying, by the system, a first weight to the first interaction communication and a second weight to the second interaction communication based on a result of a comparison of a first benefit and a second benefit, wherein the first benefit is associated with the first interaction communication being presented before the second interaction communication, wherein the second benefit is associated with the second interaction communication being presented before the first interaction communication.

10. The method of claim 9, further comprising:
based on determining that the first weight is higher than the second weight, controlling, by the system, the first virtual agent device and the second virtual agent device to have the first virtual agent device present the first interaction communication via the interface to the user before the second virtual agent device presents the second interaction communication via the interface to the user.

11. The method of claim 1, further comprising:
determining, by the system, a profile update associated with the user based on the interaction, wherein the profile update comprises update information that relates to a dialog of the interaction, the context, a sentiment of the user, the personality attribute associated with the user, a virtual-agent personality attribute associated with the virtual agent device, an environmental condition of an environment associated with the user, a goal of the interaction, or a result of the interaction; and
storing, by the system, the profile update in a user profile associated with the user.

12. The method of claim 1, wherein the virtual agent device is a first virtual agent device, wherein the interaction is a first interaction, wherein the characteristic is a first characteristic, and wherein the method further comprises:
retrieving, by the system, the user profile from a data store; and
controlling, by the system, a second characteristic of a second virtual agent device during a second interaction between the second virtual agent device and the user based on profile information stored in the user profile, wherein the profile information comprises the update information.

13. A system, comprising:
a processor; and
a memory that stores executable instructions that, when executed by the processor, facilitate performance of operations, comprising:
analyzing information relating to an interaction between a virtual agent device and a user to determine a user context and a personality attribute associated with the user; and
managing a characteristic of the virtual agent device during the interaction based on the user context and the personality attribute associated with the user.

14. The system of claim 13, wherein the operations comprise:
determining the user context of the user, a sentiment of the user, the personality attribute associated with the user, and an environmental condition of an environment associated with the user based on the analyzing of the information, wherein the managing the characteristic of the virtual agent device comprises managing characteristics, comprising the characteristic, of the virtual agent device during the interaction with the user based on the user context, the sentiment of the user, the personality attribute associated with the user, and the environmental condition.

15. The system of claim 14, wherein the operations comprise:
based on the user context, the sentiment of the user, the personality attribute associated with the user, and the environmental condition, adjusting at least one parameter of at least one characteristic of the characteristics of the virtual agent device to adjust a presentation of verbal words by the virtual agent device to the user.

16. The system of claim 15, wherein the at least one characteristic is selected from a group of characteristics comprising a rate of the presentation of the verbal words by the virtual agent device to the user, a tone of a virtual voice of the virtual agent device in connection with the presentation of the verbal words, an inflection of the virtual voice of the virtual agent device in connection with the presentation of the verbal words, and a cadence of the virtual voice of the virtual agent device in connection with the presentation of the verbal words.

17. The system of claim 13, wherein the operations comprise:
determining virtual-agent personality attributes of the virtual agent device based on personality attributes, comprising the personality attribute, associated with the user; and
mapping the virtual-agent personality attributes to characteristics, comprising the characteristic, of the virtual agent device, wherein the managing the characteristic comprises managing the characteristics of the virtual agent device based on the mapping, the user context, and the personality attributes associated with the user.

18. The system of claim 17, wherein the virtual-agent personality attributes of the virtual agent device correspond to, emulate, or complement the personality attributes associated with the user.

19. A machine-readable storage medium, comprising executable instructions that, when executed by a processor, facilitate performance of operations, comprising:
analyzing data relating to an interaction between a virtual agent device and a user to determine a context and a personality attribute associated with the user; and
controlling a characteristic of the virtual agent device during the interaction with the device based on the context and the personality attribute associated with the user, wherein the characteristic relates to a presentation of verbal words by the virtual agent device.

20. The machine-readable storage medium of claim 19, wherein the operations further comprise:
determining the context of the user, a sentiment of the user, the personality attribute associated with the user, and an environmental condition of an environment associated with the user based on the analyzing of the data, wherein the controlling of the characteristic of the virtual agent device comprises controlling characteristics, comprising the characteristic, of the virtual agent device during the interaction with the user based on the context of the user, the sentiment of the user, the personality attribute associated with the user, and the environmental condition.
